(19) United States
(12) Patent Application Publication
(10) Pub. No.: US 2024/0313260 A1
(43) Pub. Date: Sep. 19, 2024

(54) SUPRAMOLECULAR SOLID ELECTROLYTES AND RECYCLABLE BATTERIES INCLUDING SUPRAMOLECULAR SOLID ELECTROLYTES

(71) Applicant: The Regents of the University of California, Oakland, CA (US)

(72) Inventors: Brett A. Helms, Oakland, CA (US); Jiwoong Bae, Berkeley, CA (US); Dong-Min Kim, Emeryville, CA (US); Jiajun Yan, Berkeley, CA (US)

(21) Appl. No.: 18/597,908

(22) Filed: Mar. 6, 2024

Related U.S. Application Data
(60) Provisional application No. 63/488,714, filed on Mar. 6, 2023.

(51) Int. Cl. H01M 10/0565; H01M 4/02; H01M 4/525; H01M 4/58

(52) U.S. Cl. CPC H01M 10/0565; H01M 4/525; H01M 4/5825; H01M 2004/027; H01M 2004/028; H01M 2300/0082; H01M 2300/0085

(57) ABSTRACT

Provided herein is a supramolecular organo-ionic electrolyte, comprising, a supramolecular building unit, an alkali metal salt, a coordinating ligand, and optionally, a zwitterionic polymer. Also provided herein is an all-solid-state electrochemical metal cell and methods of making the same, comprising an anode active material, a cathode active material, and a supramolecular organo-ionic electrolyte, wherein the supramolecular organo-ionic electrolyte is positioned between the anode active material and the cathode active material. Further provided herein is a method of deconstructing and recycling the all-solid-state electrochemical metal cell.

### CROSS-REFERENCES TO RELATED APPLICATIONS

This application claims the benefit of and the priority to U.S. Provisional Application No. 63/488,714 filed Mar. 6, 2023, which is hereby incorporated by reference in its entirety for all purposes.

### STATEMENT AS TO RIGHTS TO INVENTIONS MADE UNDER FEDERALLY SPONSORED RESEARCH AND DEVELOPMENT

This invention was made with government support under Contract No. DE-AC02-05CH11231 awarded by the U.S. Department of Energy and under Award No. DE-0001450 awarded by the U.S. Department of Energy. The government has certain rights in this invention.

### FIELD

This disclosure relates generally to batteries and, more particularly, to solid-state batteries.

### BACKGROUND

Solid-state batteries (SSBs) are highly sought after to improve the safety of electric vehicles. However, the manufacturing of SSBs remains a challenge due to the difficulty in creating conformal interfaces between solid electrolyte particles and active materials in battery electrodes. Current interfacing strategies implement high temperature and high pressure to create composite electrodes from solid electrolytes and active materials and to assemble batteries comprising them alongside solid-electrolyte separators, metal anodes, and current collectors. In doing so, SSBs become difficult to recycle at end of life, owing to the adhesive character of interphases formed during thermal processing. Solid electrolytes whose properties facilitate SSB manufacturing, as well as deconstruction and recycling, at end of life, while offering sustainable SSB performance in the use phase, are urgently needed.

### BRIEF SUMMARY

Provided herein is a supramolecular organo-ionic electrolyte, comprising, a supramolecular building unit, an alkali metal salt, a coordinating ligand, and optionally, a zwitterionic polymer.

Also provided herein is a supramolecular organo-ionic electrolyte, comprising a polyfunctional zwitterionic small molecule according to Formula I:

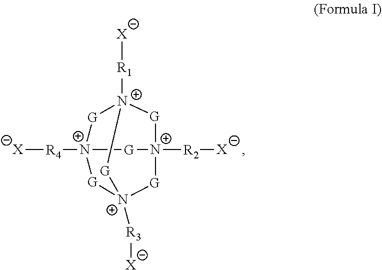

an alkali metal salt, a coordinating ligand, and optionally, a zwitterionic polymer, wherein,
R₁, R₂, R₃, and R₄ are independently selected from a substituted or unsubstituted C₁₋₁₂ alkyl,
G is C₁₋₆ alkyl, and
X is —SO₃⁻, —CO₂⁻, —BF₃⁻, —CH₂—(CO⁻)═CH—CO—Y, —SO₂—N⁻—SO₂—Y, wherein Y is F, CF₃, a substituted or unsubstituted alky, a substituted or unsubstituted aryl, a substituted or unsubstituted haloalkyl, or a substituted or unsubstituted haloaryl.

Also provided herein is an all-solid-state electrochemical metal cell, comprising an anode active material, a cathode active material, and a supramolecular organo-ionic electrolyte according to embodiment 1, wherein the supramolecular organo-ionic electrolyte is positioned between the anode active material and the cathode active material.

Also provided herein is a method of making an all-solid-state electrochemical metal cell, comprising milling together a supramolecular building unit according to Formula I:

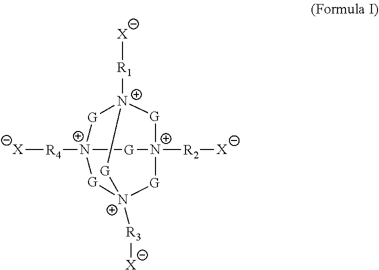

wherein,
R₁, R₂, R₃, and R₄ are independently selected from a substituted or unsubstituted C₁₋₁₂ alkyl,
G is C₁₋₆ alkyl, and
X is SO₃⁻, CO₂⁻, —BF₃⁻, CH₂—(CO⁻)═CH—CO—Y, SO₂—N⁻—SO₂—Y, wherein Y is F, CF₃, a substituted or unsubstituted alky, a substituted or unsubstituted aryl, a substituted or unsubstituted haloalkyl, or a substituted or unsubstituted haloaryl;
   with an alkali metal salt, a coordinating ligand, and optionally, a zwitterionic polymer, thereby making a milled organo-ionic electrolyte powder, placing the milled organo-ionic electrolyte powder in between a cathode active material and an anode active material, wherein the cathode active material and the anode cathode material are further separated by a separator, heating to above 100° C. to melt the milled organo-ionic electrolyte powder making a viscoelastic liquid; and cooling the viscoelastic liquid making an organo-ionic conductor, wherein in the heating step, the viscoelastic liquid infiltrates the cathode active material surface to make the organo-ionic conductor and wherein the cooled organo-ionic conductor with the separator and the anode active material comprise the all-solid-state electrochemical metal cell.

Further provided herein is a method of deconstructing the all-solid-state electrochemical metal cell, comprising submerging the organo-ionic conductor in a solvent, dissolving the organo-ionic conductor, and isolating the supramolecular organo-ionic electrolyte from cathode active material, thereby leaving a deconstructed cathode active material wherein the deconstructed cathode active material is free of the supramolecular organo-ionic electrolyte.

The details of one or more embodiments are set forth in the drawings and the description below. Other features, objects, and advantages will be apparent from the description and drawings, and from the claims.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1: Shows rheology studies of ORION 1:2 conductor. Panel A shows a plot depicting the storage modulus (G′), loss modulus (G″), and phase change (tan δ). Panel B shows complex viscosity (η*) for ORION 1:2 at 45° C. The rheology test was conducted in a nitrogen filled plastic bag.

FIG. 2A: Shows chemical structures for different components of an organo-ionic conductor including lithium bis(trifluoromethanesulfoxyl)imide (LiTFSI), 1,2-dimethoxyethane (DME), a tetrafunctional zwitterionic SBU, a poly(sulfobetaine methacrylate)(PSBMA) viscosity modifier.

FIG. 2B: Shows a plot of the temperature-dependent ionic conductivities (o) for organo-ionic conductors featuring an equimolar ratio of LiTFSI and DME and varying molar ratios of SO₃⁻:Li⁺ of 1:x, where x=1, 2, or 4.

FIG. 2C: Shows a plot comparing the temperature-dependent ionic conductivities based on molar ratio.

FIG. 2D: Shows a plot of differential scanning calorimetry (DSC) of organo-ionic conductors.

FIG. 2E: Shows a plot of the glass transition temperature (T_{g}) for the organo-ionic conductors.

FIG. 2F: Shows a plot of the powder X-ray diffraction (PXRD) patters for organo-ionic conducts and a Li(DME)TFSI solvate crystalline solid.

FIG. 3A: Shows a photograph of organo-ionic conductor showing limits of salt incorporation at different ratios of So₃⁻:Li⁺:DME.

FIG. 3B: Represents an Arrhenius plot for ionic conductivity of organo-ionic conductors at different ratios of So₃⁻:Li⁺:DME.

FIG. 4A. Represents an Arrhenius plot for ionic conductivity of organo-ionic conductors and LiTSI-DME based on conductivity data between 20 and 45° C.

FIG. 4B. Represents a bar graph of activation energy comparison between organo-ionic conductors and LiTFSI-DME based on conductivity data between 20 and 45° C.

FIG. 5A: Shows a plot of X-ray diffraction characteristics of organo-ionic conductors where the components include LiTFSI, SBU, LiTFSI-DME, and LiTFSI-SBU.

FIG. 5B: Shows a plot of X-ray diffraction characteristics of organo-ionic conductors where different ratios of the organo-ionic conductor are used.

FIG. 6A: Shows a plot of molecular dynamics (MD) simulations of the coordination number (CN) of Li⁺ with O atoms in SBU, DME, and TFSI⁻.

FIG. 6B: Shows a plot of the percentage of Li⁺ ions that are coordinated with 0, 1, 2, 3, or 4 SO₃⁻ compared to the total number of Li⁺ ions based on molecular dynamics (MD) simulations.

FIG. 7: Shows a bar graph representing the percent degree of networking as a ratio of the sulfonate groups that are connected by others among total sulfonates.

FIG. 8A: Shows a plot of voltage as a function of time of organo-ionic conductors in lithium plating and stripping for ORION 1:1 conducted at 45° C. in a Li—Li symmetric cell.

FIG. 8B: Shows a plot of voltage as a function of time of organo-ionic conductors in lithium plating and stripping for ORION 1:2 conducted at 45° C. in a Li—Li symmetric cell.

FIG. 8C: Shows a plot of voltage as a function of time of organo-ionic conductors in lithium plating and stripping for ORION 1:4 conducted at 45° C. in a Li—Li symmetric cell.

FIG. 8D: Shows a plot of long-term Li⁺ plating/stripping cycling test with ORION 1:2 with the cycling range of 0 to 500 cycles. The inserts show specific ranges from 1 to 2, 251 to 252, and 499 to 500 cycles, conducted at 45° C. in a Li—Li symmetric cell.

FIG. 9A: Shows a impedance plot of Li|ORION 1:2|Li symmetric cell at 45° C. before and after 10 hours of dwelling.

FIG. 9B: Shows a impedance plot of Li|ORION 1:2|Li symmetric cell at 60° C. before and after 10 hours of dwelling.

FIG. 10A: Shows a schematic of the first step in fabricating all solid-state lithium metal cells from ball-milled ORION powders, which are initially sandwiched between a porous cathode and Li metal anode.

FIG. 10B: Shows a schematic of the second step in fabricating all solid-state lithium metal cells by heating above 100° C., a temperature in which ORION conductors are viscoelastic liquids that can infiltrate porous cathodes while also conforming to the Li metal surface.

FIG. 10C: Shows a schematic of the third step in fabricating all solid-state lithium metal cells where after cooling, the ORION conductor solidifies, creating and all-solid-state lithium metal cell.

FIG. 10D: Shows a synchrotron hard X-ray tomography image of an assembled ORION SSB.

FIG. 10E: Shows a synchrotron hard X-ray tomography image of an ORION SSB after thermal conditioning.

FIG. 11A: Shows a picture of ORION solid powder consisting of SBU powders and LiTFSI-DME crystals at 0 minutes of heating at 100° C.

FIG. 11B: Shows a picture of SBU, LiTFSI and DME as they begin to dissociate and re-coordinate 2 minutes after heating at 100° C.

FIG. 11C: Shows a picture of supramolecular interactions among SBU, Li⁺, TFSI⁻, and DME forming ORION 5 minutes after heating at 100° C.

FIG. 12A: Shows a plot of voltage versus specific capacity depicting all solid-state lithium metal cell performance at a current density of 50 μA cm⁻².

FIG. 12B: Shows a plot of specific capacity versus cycle number depicting cycling performance of Li|ORION|LiFePO4 batteries under 50 μA cm⁻².

FIG. 12C: Shows a plot of voltage versus specific capacity depicting all solid-state lithium metal cell performance at a current density of 100 μA cm⁻².

FIG. 12D: Shows a plot of specific capacity versus cycle number depicting cycling performance of Li|ORION|LiFePO4 batteries under 10 pA cm⁻².

FIG. 12E: Shows a plot of specific capacity versus cycle number for all-sold-state lithium ion cells depicting cycling performance before recycling showing Coulombic efficiency, charge capacity, and discharge capacity at a current density of 40 μA cm⁻².

FIG. 12F: Shows pictures of the disassembly process, the dissolving of ORION in DME, and the recycled cathode.

FIG. 12G: Shows a plot of specific capacity versus cycle number for all-sold-state lithium ion cells depicting cycling performance after recycling showing Coulombic efficiency, charge capacity, and discharge capacity at a current density of 40 μA cm⁻².

FIG. 13A: Shows a plot of voltage versus specific capacity of Li|ORION|NMC532 cell from 1 to 500 cycles at a current density of 200 μA cm⁻².

FIG. 13B: Shows a plot of the specific capacity in mAh g⁻¹ at a current density of 200 μA cm⁻².

FIG. 13C: Shows a plot of Coloumbic efficiency (CE) in % of Li|ORION|NMC532 cell for 500 cycles showing that the CE reached over 99% after 500 cycles at a current density of 200 μA cm⁻².

FIG. 14: Shows a plot depicting area-specific resistance (ASR) of all-solid-state ORION cells over time calculated for Li|ORION|LFP for 500 cycles.

FIG. 15: Shows an optical images of SBU-NaTFSI mixtures after heating at 110° C., showing a transition between transparent glassy solids at sulfonate:NaTFSI ratios of 1.0:0.5-1.0 and opaque crystal-in-glass composites at sulfonate:NaTFSI ratios >1.0:1.0.

FIG. 16: Shows an overlay of powder X-ray diffraction plots for SBU-NaTFSI materials with varying ratios where each SBU has four sulfonates and the ratios indicated in the legend reflects the number of sulfonates in the SBU relative to NaTFSI.

FIG. 17: Shows an optical image of SBU-NaTFSI-DME mixtures. The mixtures were composed with a ratio of SBU(SO₃⁻):NaTFSI:DME (G1(-O-))=1:1:x (where x=1.0, 1.5, 2.0, 2.5, or 3.0) and heated at 110° C.

FIG. 18: Shows an optical image of SBU-NaTFSI-DEGDME dissolved mixtures. The mixtures were composed with a ratio of SBU(SO₃⁻):NaTFSI:DEGDME (G2(-O-))=1:1:x (where x=1.0, 1.5, 2.0, 2.5, 3.0, or 3.5) and heated at 110° C.

FIG. 19: Shows an overlay of differential scanning calorimetry (DSC) plots for analysis of the glass transition temperatures, T_{g}, for ORION solid electrolytes.

FIG. 20: Shows an overlay of differential scanning calorimetry (DSC) plots for analysis of the glass transition temperatures, T_{g}, for ORION solid electrolytes.

FIG. 21: Shows an ionic conductivity plot for ORION solid electrolytes.

FIG. 22: Shows an ionic conductivity plot for ORION solid electrolytes.

FIG. 23: Shows the voltage profile of Na|ORION|Na cycling.

FIG. 24: Shows the voltage profile of sodium symmetric cell (Na|ORION|Na) cycling across cycles 1-10.

FIG. 25: Shows the voltage profile of sodium symmetric cell (Na|ORION|Na) cycling across cycles 70-80.

### DETAILED DESCRIPTION

Before the present disclosure is described in detail, it is to be understood that the terminology used herein is for purposes of describing particular examples and embodiments only and is not intended to be limiting.

In the present disclosure, a tetrafunctional zwitterionic supramolecular building unit (SBU), 3,30,300,3000-(1,3,5,7-tetraazaadamantane-1,3,5,7-tetraium-1,3,5,7-tetrayl)tetrakis(propane-1-sulfonate) is shown to network with alkali metal salts and solvates thereof, creating from them organo-ionic (ORION) lithium-ion conductors. Notably, these ORION conductors are viscoelastic solid electrolytes at typical SSB operating temperatures (−45° to 45° C.) yet viscoelastic liquids at temperatures of only 100° C. In the liquidus state, ORION conductors have excellent wetting characteristics for both lithium metal anodes and porous cathodes comprising either lithium iron phosphate (LFP) or LiNi_{0.5}Mn_{0.3}Co_{0.2}O₂ (NMC532) active materials. Consequently, ORION SSBs can be fabricated with conformal interfaces to both electrodes using low-intensity thermal processing. It is further shown that ORION solid electrolytes can be recovered from SSBs at end of life using a solvent process, which enables direct cathode recycling. Second-life ORION SSBs are shown to recover 90% of their initial capacity and were able to sustain it for an additional 100 cycles with 84% capacity retention. The present disclosure showcases an intriguing vantage point provided by supramolecular chemistry when exploring the design space of ORION conductors to meet ongoing codesign challenges in SSBs related to manufacturing, performance, and recycling circularity at end of life.

In the fabrication of solid-state cells with the disclosed ORION conductors, the conductors take on different attributes at different temperatures. By becoming a viscoelastic liquid at higher temperatures, the conductor electrolytes make for an ideal infiltrator of porous surfaces during manufacturing and also ideal for manufacture of a recyclable material. Prior to the present invention, recycling current, liquid-based EV batteries involved a laborious process. It involves complex separations to refine the metal salts before they can be turned back into high-performing cathodes for new batteries. However, switching from a combustible liquid electrolyte to a noncombustible electrolyte imposes its own challenges-like needing to separate the metals making up the electrolyte from those of the cathode. A new way to build SSBs that makes it easier to recycle battery cathodes will help to minimize the amount of new materials that need to be extracted from mineral resources for future battery production.

The new SSBs of the present disclosure work by making use of the special solid electrolyte disclosed herein, i.e., organo ionic (ORION) lithium-ion conductors. Again, the ORION conductors of the present disclosure have been specifically developed to have certain properties that make them ideal candidates for SSBs.

While the ORION-filled batteries of the present disclosure are operating throughout their life-cycle, temperatures typically stay between −40 to 45° C. At these temperatures, the ORION conductors are viscoelastic solids, which allows for normal SSB operation. But after a battery reaches its end-of life, the ORION conductors can advantageously be heated and then dissolved, allowing recyclers to recover the cathode active material directly, which can immediately go back into electrode fabrication and battery assembly.

The development of the ORION conductors of the present disclosure sets SSBs on a more viable path of practical adoption. The unique properties of the conductors help SSBs avoid a major pitfall, i.e., intensive recycling processes, thereby opening the door for a new advancement in the field of EV. By allowing for direct cathode recycling, there is no need to waste energy in recycling batteries to their base metals and then remanufacturing each component all over again to make more batteries.

With the present invention, recycling is made easier, and battery quality does not suffer. It has been found that the recycled material works with high efficiency when placed into new batteries. In fact, studies show that refurbished cells recover at least 90% of their capacity and sustain it in their second life, with fade rates comparable to their first life. Quite surprisingly, recycled battery parts are essentially like new.

With easy and efficient recycling, the disclosed batteries can be manufactured with less new materials, which advantageously reduces both the need to mine for more materials and the amount landfilled for metals that are difficult to recover from EV batteries. Other advantages of the present invention will be apparent from the detailed description and examples provided herein.

### I. Definitions

In this specification and in the claims that follow, reference will be made to a number of terms that shall be defined to have the following meanings:

As used herein, the terms “optional” or “optionally” mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

As used herein, the term “coordinating ligand” refers to a component which coordinates alkali metal ions of alkali metal salts in an electrolyte. Examples of ligands include, but are not limited to, ethers, orthoesters, carbonates, lactones, sulfoxides, sulfones, sultones, sulfonamides, amides, phosphoramide, carbamates, and combinations thereof.

As used herein, the term “additive” refers to a component comprising a fluorinated ether, a fluorinated orthoester, a fluorinated carbonate, a fluorinated lactone, a fluorinated sulfoxide, a fluorinated sulfone, a fluorinated sultone, a fluorinated sulfonamide, a fluorinated amide, a fluorinated carbamate, a fluorinated urea, or any combination thereof.

As used herein, the term “alkali metal salt” refers to a component comprising at least one alkali metal cation and a counter anion. Examples of alkali metal salts contain anions such as chlorate, perchlorate, nitrate, phosphate, hexafluorophosphate, borate, tetrafluoroborate, difluoro(oxalate)borate, bis(oxalate)borate, bis(fluorosulfonyl)imide, bis(trifluoromethane)sulfonimide, closo-dodecaborates, halogenated closo-dodecaborates, closo-carboranes, halogenated closo-carboranes, and combinations thereof. In some embodiments, the alkali metal salt is a sodium salt. In some embodiments, the alkali metal salt is a lithium salt. In some embodiments, the alkali metal salt is a potassium salt.

As used herein, the term “polymer” refers to a molecule composed of repeating structural units, referred to herein as monomers or repeat units, connected by covalent chemical bonds. Polymers are generally characterized by a high molecular weight, such as a molecular weight greater than 100 atomic mass units (amu), greater than 500 amu, greater than 1000 amu, greater than 10000 amu or greater than 100000 amu. In some embodiments, a polymer may be characterized by a molecular weight provided in g/mol or kg/mol, such as a molecular weight of about 200 kg/mol or about 80 kg/mol. The term polymer includes homopolymers, or polymers consisting essentially of a single repeating monomer subunit. The term polymer also includes copolymers, which are formed when two or more different types of monomers are linked in the same polymer. Copolymers may comprise two or more monomer subunits, and may include random, block, alternating, segmented, grafted, tapered and other copolymers. Useful polymers include organic polymers that may be in amorphous, semi-amorphous, crystalline or partially crystalline states.

As used herein, the term “repeat unit” refers to a part of a polymer that represents a repetitive structure of the polymer chain, the repetition of which would make up the complete polymer chain with the exception of end groups corresponding to terminal ends of the polymer chain. A repeat unit may also be referred to herein as a monomer. Repeat units may be identified in a polymer structure by brackets or parentheses and include a subscript ‘n’ or ‘z’, which represents the degree of polymerization. In some embodiments, values for subscript ‘n’ or ‘z’ include integers selected from, for example, 1 to 100, 5 to 500, 10 to 500, 10 to 1000, 50 to 900, 100 to 800, or 200 to 500. It will be appreciated that a value for subscript ‘n’ or ‘z’ in a polymer may not be explicitly provided, consistent with use by skilled artisans in the field of polymer chemistry.

As used herein, the terms “porosity,” “porous,” and “microporosity” refers to a characteristic of a material describing the inclusion of voids, channels, openings, recessed regions, etc., also referred to herein as pores or micropores, in the body of material. In some embodiments, the pores have a cross sectional dimension of about 2 and 5 μm or about 1 and 10 μm. Pores may have, for example, a cross sectional dimension of about 9 μm, 8 μm, 7 μm, 6 μm, 5 μm, 4 μm, 3 μm, or 2 μm or less. In some embodiments, the micropores have a cross sectional dimension of about 2 nm or less. Micropores may have, for example, a cross sectional dimension of about 1.7 nm or less, 1.5 nm or less, 1.2 nm or less, 1 nm or less, or 0.8 nm or less. The inclusion of pores or micropores in a material may allow for other materials, such as gases, liquids, ions, etc., to pass through the micropores.

As used herein, the term “electrochemical metal cell” refers to a device that produces electrical energy through chemical reactions. Example of an electrochemical metal cell include batteries and fuel cells. Batteries may include solid-state batteries, semi-solid batteries, wet cell batteries, dry cell batteries, flow batteries, solar flow batteries, primary batteries, secondary batteries, etc. A battery may refer to an assembly of a plurality of individual electrochemical cells, such as arranged in a series configuration. Example electrochemical cells include an anode, a cathode, a separator between the anode and the cathode, and an electrolyte. Electrochemical cells may further include a current collector in electrical contact with an electrode and/or an electrolyte and may be used, in part, to provide a conductive path between the electrode and a load. Where the battery is a solid-state battery, the term “all-solid-state electrochemical metal cell” is used herein.

As used herein, the term “anode active material” refers to an electrode in an electrochemical metal cell where oxidation occurs during discharge of the electrochemical metal cell. In some embodiments, an anode active material is identified in an electrochemical metal cell as the negative electrode, where electrons are emitted during discharge for use by a load. In some embodiments, an anode active material oxidizes material and releases positive ions to an electrolyte during discharge.

As used herein, the term “cathode active material” refers to an electrode in an electrochemical metal cell where reduction occurs during discharge of the electrochemical metal cell. In some embodiments, a cathode active material is identified in an electrochemical metal cell as the positive electrode, where electrons are received during discharge after use by a load. In some embodiments, a cathode active material reduces positive ions received from an electrolyte during discharge.

As used herein, the term “separator” refers to an ion conductive barrier used to separate an anode active material and a cathode active material in an electrochemical metal cell. In some embodiments, a separator is a porous or semi-permeable membrane that restricts the passage of certain materials across the membrane. In some embodiments, a separator provides a physical spacing between the anode active material and the cathode active material in an electrochemical metal cell. In some embodiments, a separator is not electrically conductive and provides a gap in electrical conductivity between the anode and the cathode in an electrochemical cell. In some embodiments, the separator can be porous, particulate, fiber, or woven from electronically insulating materials further comprising a glass, a ceramic, or a polymer material.

As used herein, the term “electrolyte” refers to an ionically conductive substance or composition and may include ligands, solvents, ionic liquids, metal salts, ions such as metal ions or inorganic ions, polymers, ceramics, and other components.

As used herein, the term “anode electrolyte” refers to an electrolyte in an electrochemical metal cell in contact with an anode active material. An anode electrolyte may further be in contact with a separator in an electrochemical metal cell.

As used herein, the term “cathode electrolyte” refers to an electrolyte in an electrochemical metal cell in contact with a cathode active material. A cathode electrolyte may further be in contact with a separator in an electrochemical metal cell.

As used herein, the term “alkyl,” by itself or as part of another substituent, refers to a straight or branched, saturated, aliphatic radical having the number of carbon atoms indicated. Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₃, C₂₋₄, C₂₋₅, C₂₋₆, C₂₋₇, C₂₋₈, C₂₋₉, C₂₋₁₀, C₂₋₁₁, C₂₋₁₂, C₃₋₄, C₃₋₅, C₃₋₆, C₃₋₇, C₃₋₈, C₃₋₉, C₃₋₁₀, C₃₋₁₁, C₃₋₁₂, C₄₋₅, C₄₋₆, C₄₋₇, C₄₋₈, C₄₋₉, C₄₋₁₀, C₄₋₁₁, C₄₋₁₂, C₅₋₆, C₅₋₇, C₅₋₈, C₅₋₉, C₅₋₁₀, C₅₋₁₁, C₅₋₁₂, C₆₋₇, C₆₋₈, C₆₋₉, C₆₋₁₀, C₆₋₁₁, C₆₋₁₂, C₇₋₈, C₇₋₉, C₇₋₁₀, C₇₋₁₁, C₇₋₁₂, C₈₋₉, C₈₋₁₀, C₈₋₁₁, C₈₋₁₂, C₉₋₁₀, C₉₋₁₁, C₉₋₁₂, C₁₀₋₁₁, C₁₀₋₁₂, or C₁₁₋₁₂. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Alkyl groups can be substituted or unsubstituted. For example, “substituted alkyl” groups can be substituted with one or more groups selected from halo, hydroxy, amino, alkylamino, amido, acyl, nitro, cyano, and alkoxy.

As used herein, the terms “halo” and “halogen” refer to an atom selected from the group consisting of fluorine, chlorine, bromine, and iodine.

As used herein, the term “haloalkyl,” by itself or as part of another substituent, refers to an alkyl group where some or all of the hydrogen atoms are replaced with halogen atoms. As for alkyl groups, haloalkyl groups can have any suitable number of carbon atoms, such as C₁₋₆. For example, haloalkyl includes trifluoromethyl, fluoromethyl, chloromethyl, bromoethyl, and the like.

As used herein, the term “amino” refers to a moiety —NR₂, wherein each R group is H or alkyl. An amino moiety can be ionized to form the corresponding ammonium cation. “Dialkylamino” refers to an amino moiety wherein each R group is alkyl.

As used herein, the term “sulfonyl” refers to a moiety —SO₂R, wherein the R group is alkyl, haloalkyl, or aryl. An amino moiety can be ionized to form the corresponding ammonium cation.

As used herein, the term “hydroxy” refers to the moiety —OH.

As used herein, the term “cyano” refers to a carbon atom triple-bonded to a nitrogen atom (i.e., the moiety —C≡N).

As used herein, the term “carboxy” refers to the moiety —C(O)OH. A carboxy moiety can be ionized to form the corresponding carboxylate anion.

As used herein, the term “amido” refers to a moiety —NRC(O)R or —C(O)NR₂, wherein each R group is H or alkyl.

As used herein, the term “acyl” refers to a moiety —C(O)R, wherein R is alkyl.

As used herein, the term “nitro” refers to the moiety —NO₂.

As used herein, the term “oxo” refers to an oxygen atom that is double-bonded to a compound (i.e., O═).

As used herein, the term “aryl,” by itself or as part of another substituent, refers to an aromatic ring system having any suitable number of carbon ring atoms and any suitable number of rings. Aryl groups can include any suitable number of carbon ring atoms, such as C₆, C₇, C₈, C₉, C₁₀, C₁₁, C₁₂, C₁₃, C₁₄, C₁₅ or C₁₆, as well as C₆₋₁₀, C₆₋₁₂, or C₆₋₁₄. Aryl groups can be monocyclic, fused to form bicyclic (e.g., benzocyclohexyl) or tricyclic groups, or linked by a bond to form a biaryl group. Representative aryl groups include phenyl, naphthyl and biphenyl. Other aryl groups include benzyl, having a methylene linking group. Some aryl groups have from 6 to 12 ring members, such as phenyl, naphthyl or biphenyl. Other aryl groups have from 6 to 10 ring members, such as phenyl or naphthyl. Some other aryl groups have 6 ring members, such as phenyl. Aryl groups can be substituted or unsubstituted. For example, “substituted aryl” groups can be substituted with one or more groups selected from halo, hydroxy, amino, alkylamino, amido, acyl, nitro, cyano, and alkoxy.

As used herein, the term “heteroaryl,” by itself or as part of another substituent, refers to a monocyclic or fused bicyclic or tricyclic aromatic ring assembly containing 5 to 16 ring atoms, where from 1 to 5 of the ring atoms are a heteroatom such as N, O or S. Additional heteroatoms can also be useful, including, but not limited to, B, Al, Si and P. The heteroatoms can be oxidized to form moieties such as, but not limited to, —S(O)— and —S(O)₂—. Heteroaryl groups can include any number of ring atoms, such as C₅₋₆, C₃₋₈, C₄₋₈, C₅₋₈, C₆₋₈, C₃₋₉, C₃₋₁₀, C₃₋₁₁, or C₃₋₁₂, wherein at least one of the carbon atoms is replaced by a heteroatom. Any suitable number of heteroatoms can be included in the heteroaryl groups, such as 1, 2, 3, 4; or 5, or 1 to 2, 1 to 3, 1 to 4, 1 to 5, 2 to 3, 2 to 4, 2 to 5, 3 to 4, or 3 to 5. For example, heteroaryl groups can be C₅₋₈ heteroaryl, wherein 1 to 4 carbon ring atoms are replaced with heteroatoms; or C₅₋₈ heteroaryl, wherein 1 to 3 carbon ring atoms are replaced with heteroatoms; or C₅₋₆ heteroaryl, wherein 1 to 4 carbon ring atoms are replaced with heteroatoms; or C₅₋₆ heteroaryl, wherein 1 to 3 carbon ring atoms are replaced with heteroatoms. The heteroaryl group can include groups such as pyrrole, pyridine, imidazole, pyrazole, triazole, tetrazole, pyrazine, pyrimidine, pyridazine, triazine (1,2,3-, 1,2,4- and 1,3,5-isomers), thiophene, furan, thiazole, isothiazole, oxazole, and isoxazole. The heteroaryl groups can also be fused to aromatic ring systems, such as a phenyl ring, to form members including, but not limited to, benzopyrroles such as indole and isoindole, benzopyridines such as quinoline and isoquinoline, benzopyrazine (quinoxaline), benzopyrimidine (quinazoline), benzopyridazines such as phthalazine and cinnoline, benzothiophene, and benzofuran. Other heteroaryl groups include heteroaryl rings linked by a bond, such as bipyridine. Heteroaryl groups can be substituted or unsubstituted. For example, “substituted heteroaryl” groups can be substituted with one or more groups selected from halo, hydroxy, amino, alkylamino, amido, acyl, nitro, cyano, and alkoxy.

The heteroaryl groups can be linked via any position on the ring. For example, pyrrole includes 1-, 2- and 3-pyrrole, pyridine includes 2-, 3- and 4-pyridine, imidazole includes 1-, 2-, 4- and 5-imidazole, pyrazole includes 1-, 3-, 4- and 5-pyrazole, triazole includes 1-, 4- and 5-triazole, tetrazole includes 1- and 5-tetrazole, pyrimidine includes 2-, 4-, 5- and 6-pyrimidine, pyridazine includes 3- and 4-pyridazine, 1,2,3-triazine includes 4- and 5-triazine, 1,2,4-triazine includes 3-, 5- and 6-triazine, 1,3,5-triazine includes 2-triazine, thiophene includes 2- and 3-thiophene, furan includes 2- and 3-furan, thiazole includes 2-, 4- and 5-thiazole, isothiazole includes 3-, 4- and 5-isothiazole, oxazole includes 2-, 4- and 5-oxazole, isoxazole includes 3-, 4- and 5-isoxazole, indole includes 1-, 2- and 3-indole, isoindole includes 1- and 2-isoindole, quinoline includes 2-, 3- and 4-quinoline, isoquinoline includes 1-, 3- and 4-isoquinoline, quinazoline includes 2- and 4-quinazoline, cinnoline includes 3- and 4-cinnoline, benzothiophene includes 2- and 3-benzothiophene, and benzofuran includes 2- and 3-benzofuran.

It will be appreciated that the above groups and/or compounds, as described herein, may be optionally substituted with any number of substituents or functional moieties. That is, any of the above groups may be optionally substituted. As used herein, the term “substituted” is contemplated to include all permissible substituents of organic compounds, “permissible” being in the context of the chemical rules of valence known to those of ordinary skill in the art. In general, the term “substituted” whether preceded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and cannot be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. Furthermore, this invention is not intended to be limited in any manner by the permissible substituents of organic compounds.

The term “stable,” as used herein, preferably refers to compounds which possess stability sufficient to allow manufacture and which maintain the integrity of the compound for a sufficient period of time to be useful for the purposes detailed herein.

The term “salt,” in reference to a monomer or polymer as described herein, refers to an acid salt or base salt of the monomer or polymer. A monomer or polymer may have one or more salt moieties. Illustrative examples of salts are mineral acid salts (e.g., salts formed with hydrochloric acid, hydrobromic acid, phosphoric acid, or the like), organic acid salts (e.g., salts formed with acetic acid, propionic acid, glutamic acid, citric acid and the like), quaternary ammonium salts (e.g., salts formed with methyl iodide, ethyl iodide, or the like). Salts of basic monomers and/or polymers, e.g., those having amine groups, can be formed with acids such as of mineral acids, organic carboxylic acids, and organic sulfonic acids, e.g., hydrochloric acid, methanesulfonic acid, maleic acid, and the like. Salts of acidic monomers and/or polymers can be formed with bases including cationic salts such as alkali and alkaline earth metal salts, such as sodium, lithium, potassium, calcium, magnesium salts, as well as ammonium salts, such as ammonium, trimethyl-ammonium, diethylammonium, and tris-(hydroxymethyl)-methyl-ammonium salts. The neutral form of a monomer or polymer can be regenerated by contacting the salt with a base or acid and optionally isolating the parent compound. Counterions (e.g., anions in a polycationic polymer) may be exchanged as described herein.

Unless defined otherwise, all technical and scientific terms used herein have the same meaning as commonly understood by one of ordinary skill in the art to which this invention belongs. Although, any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

### II. The Supramolecular Organo-Ionic (ORION) Electrolyte

Disclosed herein is a supramolecular organo-ionic electrolyte, comprising, a supramolecular building unit (SBU), an alkali metal salt, a coordinating ligand, and optionally, a zwitterionic polymer. In some embodiments, the supramolecular organo-ionic electrolyte comprises an SBU, an alkali metal salt, a coordinating ligand, and a zwitterionic polymer. As used herein, a supramolecular building unit (SBU) refers to a discrete molecular species that exploits supramolecular bonds, including coordination bonds, alongside multivalency to assemble ionic compounds, including alkali metal salts, into extended, solid-state structures known as coordination solids. As used herein, a “zwitterion” is a neutral compound that has both a cation and an anion in the same molecule. Chemically, zwitterions have broad applicability because they are dielectric, non-volatile, and highly polar compounds with a large dipole moment. As used herein, a “zwitterionic polymer” refers to a polymer characterized by equal anion and cation groups on the molecular chains, which makes them highly hydrophilic and antifouling. They can resist nonspecific protein adsorption, bacterial adhesion, and biofilm formation.

In some embodiments, the supramolecular building unit is a polyfunctional zwitterionic small molecule according to Formula I:

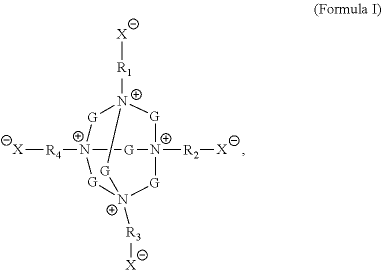

wherein, R₁, R₂, R₃, and R₄ are independently selected from a substituted or unsubstituted C₁₋₁₂ alkyl, G is C₁₋₆ alkyl, and X is —SO₃⁻, —CO₂⁻, —BF₃, —CH₂—(CO⁻)═CH—CO—Y, —SO₂—N⁻—SO₂—Y. In some embodiments, Y is F, CF₃, a substituted or unsubstituted alky, a substituted or unsubstituted aryl, a substituted or unsubstituted haloalkyl, or a substituted or unsubstituted haloaryl. In some embodiments, R₁, R₂, R₃, and R₄ are independently selected from a substituted or unsubstituted C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₆. C₂₋₇, C₂₋₈, C₂₋₉, C₂₋₁₀, C₂₋₁₁, or C₂₋₁₂ alkyl or haloalkyl. In some embodiments R₁, R₂, R₃, and R₄ are independently selected from a substituted or unsubstituted C₃₋₄, C₃₋₅, C₃₋₆, C₃₋₇, C₃₋₈, C₃₋₉, C₃₋₁₀, C₃₋₁₁, C₃₋₁₂, C₄₋₆, C₄₋₇, C₄₋₈, C₄₋₉, C₄₋₁₀, C₄₋₁₁, or C₄₋₁₂ aryl or haloaryl. In some embodiments, G is C₁₋₂, C₁₋₃, C₁₋₄, C₁₋₅, C₁₋₆, C₂₋₃, C₂₋₄, C₂₋₅, or C₂₋₆.

In some embodiments, the alkali metal salt is a lithium ion salt, a sodium ion salt, or a potassium ion salt. In some embodiments the lithium-ion salt is lithium bis(fluorosulfonyl)imide (LiFSI), Lithium bis(trifluoromethane)sulfonimide (LiTFSI), lithium triflouromethanesulfonate (LiOTf), lithium perchlorate (LiClO4), lithium tetrafluoroborate (LiBF4), lithium difluoro(oxalato)borate (LiDFOB), or lithium hexafluorophosphate (LiPF₆). In some embodiments, the lithium-ion salt is LiTFSI. In some embodiments, the sodium ion salt is sodium bis(fluorosulfonyl)imide (NaFSI), sodium trifluoromethanesulfonimide (NaTFSI), sodium trifluoromethanesulfonate (NaOTf), sodium perchlorate (NaClO₄), sodium tetrafluoroborate (NaBF₄), sodium borohydride (NaBH₄), sodium difluoro(oxalato)borate (NaDFOB), or sodium hexafluorophosphate (NaPF₆). In some embodiments, the potassium ion salt is potassium borohydride (KBH₄), potassium tetrafluoroborate (KBF₄), potassium hexafluorophosphate (KPF₆), potassium perchlorate (KClO₄), potassium trifluoromethanesulfonate (KOTf), or potassium bis(trifluoromethanesulfonyl)imide (KTFSI).

In some embodiments, the coordinating ligand is an ether, a carbonate, a sulfoxide, a sulfone, an amide, a sulfonamide, a phosphoramide, or combinations thereof. In some embodiments, the ether is 1,2-dimethoxy ethane (DME). In some embodiments, the ether is a glyme of Formula II:

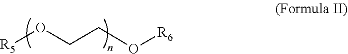

wherein, R₅ and R₆ are independent selected from a substituted or unsubstituted alky, a substituted or unsubstituted aryl, a substituted or unsubstituted haloalkyl, a substituted or unsubstituted haloaryl, or combinations thereof. In some embodiments, R₅, and R₆ are independently selected from a substituted or unsubstituted C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₆, C₂₋₇, C₂₋₈, C₂₋₉, C₂₋₁₀, C₂₋₁₁, or C₂₋₁₂ alkyl or haloalkyl. In some embodiments R₅, and R₆ are independently selected from a substituted or unsubstituted C₃₋₄, C₃₋₅, C₃₋₆, C₃₋₇, C₃₋₈, C₃₋₉, C₃₋₁₀, C₃₋₁₁, C₃₋₁₂, C₄₋₆, C₄₋₇, C₄₋₈, C₄₋₉, C₄₋₁₀, C₄₋₁₁, or C₄₋₁₂ aryl or haloaryl. In some embodiments, n is 1, 2, 3, or 4. In some embodiments, the glyme is a monoglyme, a diglyme, a triglyme, a tetraglyme, a ethyl glyme, a ethyl diglyme, a ethyl triglyme, a ethyl tetraglyme, a butyl glyme, a butyl diglyme, a butyl triglyme, a butyl tetraglyme, or a polyglyme with different R₅ and R₆ substituents.

In an embodiment, the zwitterionic polymer is a viscosity modifier. In some embodiments, the viscosity modifier comprises:

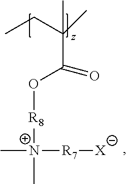

wherein ‘z’ is an integer from 10 to 500 and R₇ and R₈ are independently C₁₋₆ alkyl. In some embodiments z is an integer from 10 to 20, 10 to 30, 10 to 40, 10 to 50, 10 to 60, 10 to 70, 10 to 80, 10 to 90, 10 to 100, 10 to 120, 10 to 140, 10 to 160, 10 to 180, 10 to 200, 10 to 220, 10 to 240, 10 to 260, 10 to 280, 10 to 300, 10 to 320, 10 to 340, 10 to 360, 10 to 380, 10 to 400, 10 to 420, 10 to 440, 10 to 460, 10 to 480, 10 to 500, 10 to 50, 25 to 75, 50 to 100, 75 to 125, 100 to 150, 125 to 175, 150 to 200, 175 to 225, 200 to 250, 225 to 275, 250 to 300, 275 to 325, 300 to 350, 325 to 375, 350 to 400, 375 to 425, 400 to 450, 425 to 475, or 450 to 500. In some embodiments, R₇ and R₈ are independently C₁₋₆, C₂₋₆, C₃₋₆, C₄₋₆, or C₅₋₆ alkyl. In some embodiments, R₈ is C₂ alkyl and R₇ is C₃ alkyl. In some embodiments, the zwitterionic polymer is poly(sulfobetaine methacrylate)(PSBMA).

In some embodiment, R₁, R₂, R₃, and R₄ are each a substituted or unsubstituted C₃ alkyl. In some embodiment, G is —CH₂. In some embodiments, X is —SO₃⁻.

In some embodiments, the —SO₃⁻:Li⁺ molar ratio is 1:x, wherein x is an integer from 1 to 4. In some embodiments, the —SO₃⁻:Li⁺ molar ratio is 1:2. In some embodiments, the —SO₃⁻:Li⁺ molar ratio is 1:1, 1:2, 1:3, or 1:4.

In some embodiments, the supramolecular organo-ionic electrolyte is a viscoelastic solid at temperatures between −40° C. and 40° C., −40° C. and 45° C., −45° C. and 45° C., −45° C. and 50° C., or −50° C. and 50° C. In some embodiments, the supramolecular organo-ionic electrolyte is a viscoelastic solid at temperatures between −40° C. and 45° C. In some embodiments, the supramolecular organo-ionic electrolyte is a viscoelastic liquid at temperatures greater than 80° C., 85° C., 90° C., 95° C., 100° C., 105° C., or 110° C. In some embodiments, the supramolecular organo-ionic electrolyte is a viscoelastic liquid at temperatures greater than 100° C.

In some embodiments, the supramolecular organo-ionic electrolyte has effective ionic conductivity over the temperature range between 10° C. and 60° C., 10° C. and 59° C., 10° C. and 58° C., 10° C. and 57° C., 10° C. and 56° C., 10° C. and 55° C., 11° C. and 60° C., 12° C. and 60° C., 13° C. and 60° C., 14° C. and 60° C., 15° C. and 60° C., 16° C. and 60° C., 17° C. and 60° C., 18° C. and 60° C., 19° C. and 60° C., 20° C. and 60° C., 15° C. and 60° C., 16° C. and 59° C., 17° C. and 58° C., 18° C. and 57° C., 19° C. and 56° C., or 20° C. and 55° C. In some embodiments, the supramolecular organo-ionic electrolyte has effective ionic conductivity over the temperature range between 19° C. and 56° C.

In some embodiments, the zwitterionic polymer is up to about 15%, 14%, 13%, 12%, 11%, 10%, 9%, 8%, 7%, 6%, 5%, 4%, 3%, 2%, or 1% (w/w) relative to the polyfunctional zwitterionic small molecule of Formula I. In some embodiments, the zwitterionic polymer is up to about 10% (w/w) relative to the polyfunctional zwitterionic small molecule of Formula I. In some embodiments, the zwitterionic polymer is poly(sulfobetaine methacrylate)(PSBMA). In some embodiments, the PSBMA is up to about 15%, 14%, 13%, 12%, 11%, 10%, 9%, 8%, 7%, 6%, 5%, 4%, 3%, 2%, or 1% (w/w) relative to the polyfunctional zwitterionic small molecule of Formula I. In some embodiments, the PSBMA is up to about 10% (w/w) relative to the polyfunctional zwitterionic small molecule of Formula I.

In some embodiments, the supramolecular organo-ionic electrolyte comprises an additive. In some embodiments, the additive comprises a polymer, a conductive additive, an electrode active material, a combustion inhibition material, a binder, or combinations thereof. In some embodiments, the additive comprises a fluoroalkyl ether, a fluoroalkyl acetal, a fluoroalkyl orthoester, a fluoroalkyl carbonate, a fluoroalkyl phosphonate, or combinations thereof. In some embodiments, the additive comprises C₆₀, carbon black, acetylene black, SuperP, KetjenBlack, graphene, multi-layer graphene, single-wall carbon nanotubes, multi-wall carbon nanotubes, carbon nanofibers, carbon fiber, MXenes, metal oxides, and/or black phosphorous.

Disclosed herein is a supramolecular organo-ionic electrolyte, comprising a polyfunctional zwitterionic small molecule according to Formula I:

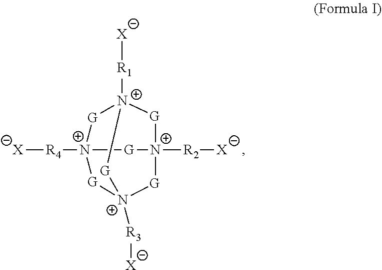

an alkali metal salt, a coordinating ligand, and optionally, a zwitterionic polymer, wherein, R₁, R₂, R₃, and R₄ are independently selected from a substituted or unsubstituted C₁₋₁₂ alkyl, G is C₁₋₆ alkyl, and X is —SO₃⁻, —CO₂⁻, —BF₃, —CH₂—(CO⁻)═CH—CO—Y, —SO₂—N⁻—SO₂—Y, wherein Y is F, CF₃, a substituted or unsubstituted alky, a substituted or unsubstituted aryl, a substituted or unsubstituted haloalkyl, or a substituted or unsubstituted haloaryl. In some embodiments, R₁, R₂, R₃, and R₄ are independently selected from a substituted or unsubstituted C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₆, C₂₋₇, C₂₋₈, C₂₋₉, C₂₋₁₀, C₂₋₁₁, or C₂₋₁₂ alkyl or haloalkyl. In some embodiments R₁, R₂, R₃, and R₄ are independently selected from a substituted or unsubstituted C₃₋₄, C₃₋₅, C₃₋₆, C₃₋₇, C₃₋₈, C₃₋₉, C₃₋₁₀, C₃₋₁₁, C₃₋₁₂, C₄₋₆, C₄₋₇, C₄₋₈, C₄₋₉, C₄₋₁₀, C₄₋₁₁, or C₄₋₁₂ aryl or haloaryl. In some embodiments, G is C₁₋₂, C₁₋₃, C₁₋₄, C₁₋₅, C₁₋₆, C₂₋₃, C₂₋₄, C₂₋₅, or C₂₋₆.

In some embodiments, the polyfunctional zwitterionic small molecule is according to Formula III:

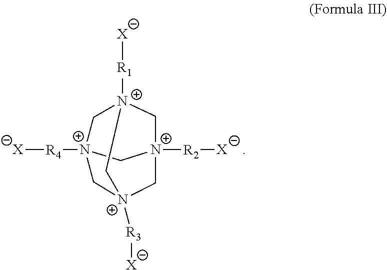

In some embodiments, the polyfunctional zwitterionic small molecule is:

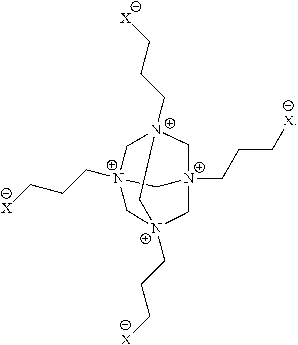

In some embodiments, X is —SO₃⁻.

### III. The all-Solid-State Electrochemical Metal Cell

Disclosed herein is an all-solid-state electrochemical metal cell, comprising an anode active material, a cathode active material, a separator, and a supramolecular organo-ionic electrolyte, wherein the supramolecular organo-ionic electrolyte is positioned with the separator between the anode active material and the cathode active material. In some embodiments, the supramolecular organo-ionic electrolyte is melted into a viscoelastic ligand. In some embodiments, the viscoelastic liquid can favorably wet the anode active material, cathode active material, and separator. In some embodiments, the viscoelastic liquid infiltrates into the separator and the cathode active material. In some embodiments, the viscoelastic liquid is rigid within the separator and the cathode active material. In some embodiments, the viscoelastic liquid cools to become a viscoelastic solid that is intertwined with the separator and the cathode active material.

In some embodiments, the anode active material is lithium metal, a lithium alloy, sodium metal, a sodium alloy, potassium metal, a potassium alloy, hard carbon, graphite, silicon, or combinations thereof. In some embodiments, the cathode active material is lithium iron phosphate (LFP) or LiNi_{0.5}Mn_{0.3}Co_{0.2}O₂ (NMC532). In some embodiments, the separator can be porous, particulate, fiber, or woven from electronically insulating materials further comprising a glass, a ceramic, or a polymer material. In some embodiments, the polymer material separator comprises one or more microporous polymers. In some embodiments, the polymer material includes one or more chelator-functionalized or amine-functionalized microporous polymers. In some embodiments, the polymer material includes an amine-functionalized microporous polymer.

In some embodiments, the all-solid-state electrochemical metal cell comprises a retention of at least 80% capacity after 100 cycles at a rate up to 0.1 mA cm⁻² at 45° C. In some embodiments, the all-solid-state electrochemical metal cell comprises a retention of at least 80%, 81%, 82%, 83%, 84%, 85%, 86%, 87%, 88%, 89%, or 90% capacity after about 100 cycles. In some embodiments, the cycle rate is up to 0.1, 0.09, 0.08, 0.07, 0.06, 0.05, 0.04, 0.03, 0.02, or 0.01 mA cm⁻² at 45° C.

In some embodiments, the all-solid-state electrochemical metal cell comprises a battery operating temperature between −40° C. and 45° C. In some embodiments, all-solid-state electrochemical metal cell comprises a battery operating temperature between −40° C. and 40° C., −40° C. and 45° C., −45° C. and 45° C., −45° C. and 50° C., or −50° C. and 50° C.

### IV. Methods of Making

Disclosed herein is a method of making an all-solid-state electrochemical metal cell, comprising milling together a supramolecular building unit according to Formula I:

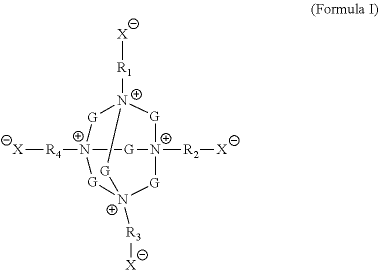

wherein, R₁, R₂, R₃, and R₄ are independently selected from a substituted or unsubstituted C₁₋₁₂ alkyl, G is C₁₋₆ alkyl, and X is SO₃⁻, CO₂⁻, —BF₃⁻, CH₂—(CO⁻)—CH—CO—Y, SO₂—N⁻—SO₂—Y, wherein Y is F, CF₃, a substituted or unsubstituted alky, a substituted or unsubstituted aryl, a substituted or unsubstituted haloalkyl, or a substituted or unsubstituted haloaryl, with an alkali metal salt, a coordinating ligand, and optionally, a zwitterionic polymer, thereby making a milled organo-ionic electrolyte powder, placing the milled organo-ionic electrolyte powder in between a cathode active material and an anode active material, wherein the cathode active material and the anode cathode material are further separated by a separator, heating to above 100° C. to melt the milled organo-ionic electrolyte powder making a viscoelastic liquid; and cooling the viscoelastic liquid making an organo-ionic conductor, wherein in the heating step, the viscoelastic liquid infiltrates the cathode active material surface to make the organo-ionic conductor and wherein the cooled organo-ionic conductor with the separator and the anode active material comprise the all-solid-state electrochemical metal cell. In some embodiments, R₁, R₂, R₃, and R₄ are independently selected from a substituted or unsubstituted C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₆, C₂₋₇, C₂₋₈, C₂₋₉, C₂₋₁₀, C₂₋₁₁, or C₂₋₁₂ alkyl or haloalkyl. In some embodiments R₁, R₂, R₃, and R₄ are independently selected from a substituted or unsubstituted C₃₋₄, C₃₋₅, C₃₋₆, C₃₋₇, C₃₋₈, C₃₋₉, C₃₋₁₀, C₃₋₁₁, C₃₋₁₂, C₄₋₆, C₄₋₇, C₄₋₈, C₄₋₉, C₄₋₁₀, C₄₋₁₁, or C₄₋₁₂ aryl or haloaryl. In some embodiments, G is C₁₋₂, C₁₋₃, C₁₋₄, C₁₋₅, C₁₋₆, C₂₋₃, C₂₋₄, C₂₋₅, or C₂₋₆.

In some embodiments, the supramolecular building unit according to Formula I is milled together with an alkali metal salt, a coordinating ligand, and a zwitterionic polymer, thereby making a milled organo-ionic electrolyte powder.

As used herein, “milling together” may refer to a suitable grinding method. As a non-limiting example, as used herein, “milling together” may be further described as ball-milling. Ball milling is a grinding method that uses a slightly inclined or horizontal rotating container that is partially filled with balls (e.g., stone or metal balls) which grind material to the necessary fineness by friction and impact with the tumbling balls. During the ball milling process, the collision between the rigid balls in a concealed container may generate localized high pressure. As a non-limiting example, ceramic, flint pebbles, and stainless steel balls may be used. Another non-limiting examples of the grinding method may include high pressure grinding rolls.

In some embodiments, the alkali metal salt is a lithium ion salt, a sodium ion salt, or a potassium ion salt. In some embodiments the lithium-ion salt is lithium bis(fluorosulfonyl)imide (LiFSI), Lithium bis(trifluoromethane)sulfonimide (LiTFSI), lithium triflouromethanesulfonate (LiOTf), lithium perchlorate (LiClO4), lithium tetrafluoroborate (LiBF4), lithium difluoro(oxalato)borate (LiDFOB), or lithium hexafluorophosphate (LiPF₆). In some embodiments, the lithium-ion salt is LiTFSI. In some embodiments, the sodium ion salt is sodium bis(fluorosulfonyl)imide (NaFSI), sodium trifluoromethanesulfonimide (NaTFSI), sodium trifluoromethanesulfonate (NaOTf), sodium perchlorate (NaClO₄), sodium tetrafluoroborate (NaBF₄), sodium borohydride (NaBH₄), sodium difluoro(oxalato)borate (NaDFOB), or sodium hexafluorophosphate (NaPF₆). In some embodiments, the potassium ion salt is potassium borohydride (KBH₄), potassium tetrafluoroborate (KBF₄), potassium hexafluorophosphate (KPF₆), potassium perchlorate (KClO₄), potassium trifluoromethanesulfonate (KOTf), or potassium bis(trifluoromethanesulfonyl)imide (KTFSI).

In some embodiments, the coordinating ligand is an ether, a carbonate, a sulfoxide, a sulfone, an amide, a sulfonamide, a phosphoramide, or combinations thereof. In some embodiments, the ether is 1,2-dimethoxy ethane (DME). In some embodiments, the ether is a glyme of Formula II:

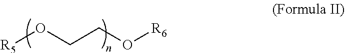

wherein, R₅ and R₆ are independent selected from a substituted or unsubstituted alky, a substituted or unsubstituted aryl, a substituted or unsubstituted haloalkyl, a substituted or unsubstituted haloaryl, or combinations thereof. In some embodiments, R₅, and R₆ are independently selected from a substituted or unsubstituted C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₆, C₂₋₇, C₂₋₈, C₂₋₉, C₂₋₁₀, C₂₋₁₁, or C₂₋₁₂ alkyl or haloalkyl. In some embodiments R₅, and R₆ are independently selected from a substituted or unsubstituted C₃₋₄, C₃₋₅, C₃₋₆, C₃₋₇, C₃₋₈, C₃₋₉, C₃₋₁₀, C₃₋₁₁, C₃₋₁₂, C₄₋₆, C₄₋₇, C₄₋₈, C₄₋₉, C₄₋₁₀, C₄₋₁₁, or C₄₋₁₂ aryl or haloaryl. In some embodiments, n is 1, 2, 3, or 4. In some embodiments, the glyme is a monoglyme, a diglyme, a triglyme, a tetraglyme, a ethyl glyme, a ethyl diglyme, a ethyl triglyme, a ethyl tetraglyme, a butyl glyme, a butyl diglyme, a butyl triglyme, a butyl tetraglyme, or a polyglyme with different R₅ and R₆ substituents.

In some embodiments, the zwitterionic polymer is poly(sulfobetaine methacrylate) (PSBMA). In some embodiments, the separator can be porous, particulate, fiber, or woven from electronically insulating materials further comprising a glass, a ceramic, or a polymer material.

In some embodiments the supramolecular building unit according to Formula I is:

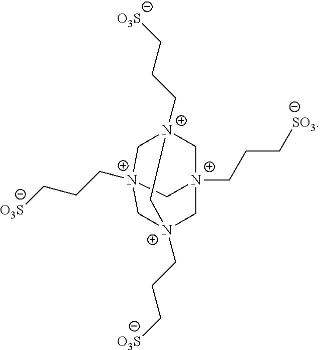

In some embodiments the viscoelastic liquid is a supramolecular organo-ionic electrolyte. As used herein, a “viscoelastic liquid” is a type of non-Newtonian fluid by a viscous component and an elastic one. Typically, a viscoelastic coordinating liquid is a blend of a ligand and a polymer, as used herein.

### V. Methods of Deconstructing

Also disclosed herein is a method of deconstructing the all-solid-state electrochemical metal cell comprising submerging the organo-ionic conductor in a solvent, dissolving the organo-ionic conductor, and isolating the supramolecular organo-ionic electrolyte from cathode active material thereby leaving a deconstructed cathode active material wherein the deconstructed cathode active material is free of the supramolecular organo-ionic electrolyte. In some embodiments, the ligand is an ether. In some embodiments, the ether is 1,2-dimethoxyethane. In some embodiments, the ligand is an ether, ester, carbonate, sulfoxide, sulfone, sulfonamide, phosphonate. In some embodiments, isolation after recycling is typically done by evaporation of the ligand. In some embodiments, to separate the salts from the SBU and other components, ion-separations techniques can be employed. A non-exhaustive list of applicable separation techniques includes ion-exchange, extractions, selective solvents, and recrystallization, all of which are separation techniques that are known to and used by those of ordinary skill in the art.

In some embodiments, the anode active material and the deconstructed cathode active material can be reused to make a recycled all-solid-state electrochemical metal cell. In some embodiments, the recycled all-solid-state electrochemical metal cell can recover at least 90% of the initial capacity of its components. In some embodiments, the recycled all-solid-state electrochemical metal cell can recover at least 80%, 81%, 82%, 83%, 84%, 85%, 86%, 87%, 88%, 89%, 90%, 91%, 92%, 93%, 94%, or 95% of the initial capacity of its components.

In some embodiments, the recycled all-solid-state electrochemical metal cell can retain at least 80% capacity for 100 cycles. In some embodiments, the recycled all-solid-state electrochemical metal cell can retain at least 75%, 76%, 77%, 78%, 79%, 80%, 81%, 82%, 83%, 84%, 85%, 86%, 87%, 88%, 89%, or 90% capacity for 100 cycles. In some embodiments, the recycled all-solid-state electrochemical metal cell can retain at least 75%, 76%, 77%, 78%, 79%, 80%, 81%, 82%, 83%, 84%, 85%, 86%, 87%, 88%, 89%, or 90% capacity for about 50, 75, 100, 125, or 150 cycles. In some embodiments, the all-solid-state electrochemical metal cell can be recycled 1, 2, 3, 4, or 5 times. In some embodiments, the all-solid-state electrochemical metal cell can be recycled up to 10 times.

Aspects of the disclosure and the invention may be further understood by reference to the following no-limiting examples.

### EXEMPLARY EMBODIMENTS

Exemplary embodiments provided in accordance with the presently disclosed subject matter include, but are not limited to, the claims and the following embodiments:
Embodiment 1: A supramolecular organo-ionic electrolyte, comprising, a supramolecular building unit, an alkali metal salt, a coordinating ligand, and optionally, a zwitterionic polymer.
Embodiment 2: The supramolecular organo-ionic electrolyte of embodiment 1, wherein the supramolecular building unit is a polyfunctional zwitterionic small molecule according to Formula I:

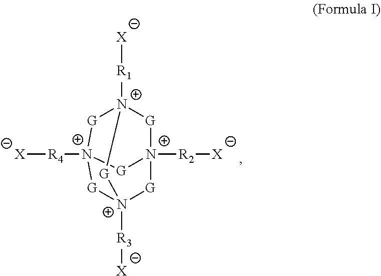

wherein,
R₁, R₂, R₃, and R₄ are independently selected from a substituted or unsubstituted C₁₋₁₂ alkyl,
G is C₁₋₆ alkyl, and
X is —SO₃⁻, —CO₂⁻, —BF₃⁻, —CH₂—(CO⁻)—CH—CO—Y, —SO₂—N⁻—SO₂—Y, wherein Y is F, CF₃, a substituted or unsubstituted alky, a substituted or unsubstituted aryl, a substituted or unsubstituted haloalkyl, or a substituted or unsubstituted haloaryl.
Embodiment 3: The supramolecular organo-ionic electrolyte of embodiment 1 and embodiment 2, wherein the alkali metal salt is a lithium ion salt, a sodium ion salt, or a potassium ion salt.
Embodiment 4: The supramolecular organo-ionic electrolyte of any one of embodiments 1 to 3, wherein the lithium-ion salt is selected from the group consisting of LiFSI, LiTFSI, LiOTf, LiClO₄, LiBF₄, LIDFOB, and LiPF₆.
Embodiment 5: The supramolecular organo-ionic electrolyte of any one of embodiments 1 to 3, wherein the sodium ion salt is selected from the group consisting of NaFSI, NaTFSI, NaOTf, NaClO₄, NaBF₄, NaBH₄, NaDFOB, and NaPF₆.
Embodiment 6: The supramolecular organo-ionic electrolyte of any one of embodiments 1 to 4, wherein the lithium-ion salt is LiTFSI.
Embodiment 7: The supramolecular organo-ionic electrolyte of any one of embodiments 1 to 6, wherein the coordinating ligand is an ether, a carbonate, a sulfoxide, a sulfone, an amide, a sulfonamide, a phosphoramide, or combinations thereof.
Embodiment 8: The coordinating ligand of embodiment 7, wherein the ether is 1,2-dimethoxy ethane (DME).
Embodiment 9: The coordinating ligand of embodiment 7, wherein the ether is a glyme of Formula II:

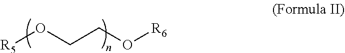

wherein,
R₅ and R₆ are independent selected from a substituted or unsubstituted alky, a substituted or unsubstituted aryl, a substituted or unsubstituted haloalkyl, a substituted or unsubstituted haloaryl, or combinations thereof, and
n is 1, 2, 3, or 4.
Embodiment 10: The supramolecular organo-ionic electrolyte of any one of embodiments 1 to 9, wherein the zwitterionic polymer is a viscosity modifier.
Embodiment 11: The supramolecular organo-ionic electrolyte of embodiment 10, wherein the viscosity modifier comprises:

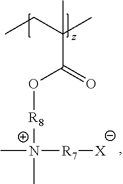

wherein
z is an integer from 10 to 500; and
R₇ and R₅ are independently C₁₋₆ alkyl.
Embodiment 12: The supramolecular organo-ionic electrolyte of embodiment 11, wherein R₈ is C₂ alkyl and R₇ is C₃ alkyl.
Embodiment 13: The supramolecular organo-ionic electrolyte of any one of embodiments 1 to 12, wherein the zwitterionic polymer is poly(sulfobetaine methacrylate) (PSBMA).
Embodiment 14: The supramolecular organo-ionic electrolyte of embodiment 2, wherein R₁, R₂, R₃, and R₄ are each a substituted or unsubstituted C₃ alkyl.
Embodiment 15: The supramolecular organo-ionic electrolyte of embodiment 2, wherein G is —CH₂.
Embodiment 16: The supramolecular organo-ionic electrolyte of embodiment 2, wherein X is —SO₃⁻.
Embodiment 17: The supramolecular organo-ionic electrolyte of any one of embodiments 1 to 16, comprising a —SO₃⁻:Li⁺ molar ratio is 1:x, wherein x is an integer from 1 to 4.
Embodiment 18: The supramolecular organo-ionic electrolyte of embodiment 17, wherein the —SO₃⁻:Li⁺ molar ratio is 1:2.
Embodiment 19: The supramolecular organo-ionic electrolyte of any one of embodiments 1 to 18, which is a viscoelastic solid at temperatures between −40° C. and 45° C.
Embodiment 20: The supramolecular organo-ionic electrolyte of any one of embodiments 1 to 18, which is a viscoelastic liquid at temperatures greater than 100° C.
Embodiment 21: The supramolecular organo-ionic electrolyte of any one of embodiments 1 to 18, with effective ionic conductivity over the temperature range between 19° C. and 56° C.
Embodiment 22: The supramolecular organo-ionic electrolyte of embodiment 13, wherein the poly(sulfobetaine methacrylate)(PSBMA) is up to about 10% (w/w) relative to the polyfunctional zwitterionic small molecule of Formula I.
Embodiment 23: The supramolecular organo-ionic electrolyte of any one of embodiments 1 to 22, further comprising an additive.
Embodiment 24: The supramolecular organo-ionic electrolyte of embodiment 23, wherein the additive comprises a polymer, a conductive additive, an electrode active material, a combustion inhibition material, a binder, or combinations thereof.
Embodiment 25: The supramolecular organo-ionic electrolyte of embodiment 22 and embodiment 23, wherein the additive comprises a fluoroalkyl ether, a fluoroalkyl acetal, a fluoroalkyl orthoester, a fluoroalkyl carbonate, a fluoroalkyl phosphonate, or combinations thereof.
Embodiment 26: A supramolecular organo-ionic electrolyte, comprising a polyfunctional zwitterionic small molecule according to Formula I:

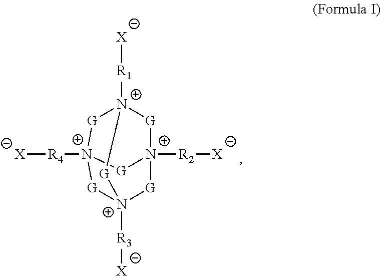

an alkali metal salt, a coordinating ligand, and optionally, a zwitterionic polymer, wherein,
R₁, R₂, R₃, and R₄ are independently selected from a substituted or unsubstituted C₁₋₁₂ alkyl,
G is C₁₋₆ alkyl, and
X is —SO₃⁻, —CO₂⁻, —BF₃⁻, —CH₂—(CO⁻)═CH—CO—Y, —SO₂—N⁻—SO₂—Y, wherein Y is F, CF₃, a substituted or unsubstituted alky, a substituted or unsubstituted aryl, a substituted or unsubstituted haloalkyl, or a substituted or unsubstituted haloaryl.
Embodiment 27: The supramolecular organo-ionic electrolyte of embodiment 26, wherein the polyfunctional zwitterionic small molecule is according to Formula III:

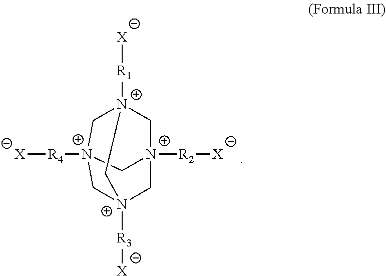

Embodiment 28: The supramolecular organo-ionic electrolyte of embodiment 26 and embodiment 27, wherein the polyfunctional zwitterionic small molecule is:

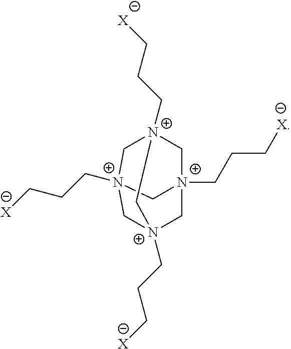

Embodiment 29: The supramolecular organo-ionic electrolyte of any one of embodiments 26 to 28, wherein X is —SO₃⁻.
Embodiment 30: An all-solid-state electrochemical metal cell, comprising an anode active material, a cathode active material, a separator, and a supramolecular organo-ionic electrolyte according to any one of embodiments 1 to 29, wherein the supramolecular organo-ionic electrolyte is positioned with the separator between the anode active material and the cathode active material.
Embodiment 31: The all-solid-state electrochemical metal cell of embodiment 30, wherein the anode active material is lithium metal, a lithium alloy, sodium metal, a sodium alloy, potassium metal, a potassium alloy, hard carbon, graphite, silicon, or combinations thereof.
Embodiment 32: The all-solid-state electrochemical metal cell of embodiment 30 and embodiment 31, wherein the cathode active material is lithium iron phosphate (LFP) or LiNi_{0.5}Mn_{0.3}Co_{0.2}O₂ (NMC532).
Embodiment 33: The all-solid state electrochemical metal cell of any one of embodiments 30 to 32, wherein the separator can be porous, particulate, fiber, or woven from electronically insulating materials further comprising a glass, a ceramic, or a polymer material.
Embodiment 34: The all-solid-state electrochemical metal cell of any one of embodiments 30 to 33, comprising a retention of at least 80% capacity after 100 cycles at a rate up to 0.1 mA cm⁻² at 45° C.
Embodiment 35: The all-solid-state electrochemical metal cell of any one of embodiments 30 to 34, comprising a battery operating temperature between −40° C. and 45° C.
Embodiment 36: A method of making an all-solid-state electrochemical metal cell, comprising milling together a supramolecular building unit according to Formula I:

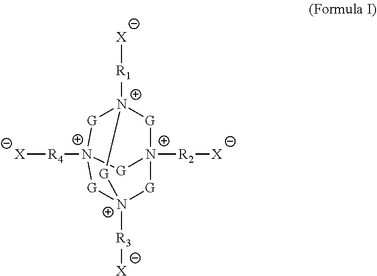

wherein,
R₁, R₂, R₃, and R₄ are independently selected from a substituted or unsubstituted C₁₋₁₂ alkyl,
G is C₁₋₆ alkyl, and
X is SO₃⁻, CO₂⁻, —BF₃⁻, CH₂—(CO⁻)═CH—CO—Y, SO₂—N⁻—SO₂—Y, wherein Y is F, CF₃, a substituted or unsubstituted alky, a substituted or unsubstituted aryl, a substituted or unsubstituted haloalkyl, or a substituted or unsubstituted haloaryl;
   with an alkali metal salt, a coordinating ligand, and optionally, a zwitterionic polymer, thereby making a milled organo-ionic electrolyte powder, placing the milled organo-ionic electrolyte powder in between a cathode active material and an anode active material, wherein the cathode active material and the anode cathode material are further separated by a separator, heating to above 100° C. to melt the milled organo-ionic electrolyte powder making a viscoelastic liquid; and cooling the viscoelastic liquid making an organo-ionic conductor, wherein in the heating step, the viscoelastic liquid infiltrates the cathode active material surface to make the organo-ionic conductor and wherein the cooled organo-ionic conductor with the separator and the anode active material comprise the all-solid-state electrochemical metal cell.
Embodiment 37: The method of embodiment 36, wherein the alkali metal salt is a lithium ion salt, a sodium ion salt, or a potassium ion salt.
Embodiment 38: The method of embodiment 36 and embodiment 37, wherein the lithium-ion salt is selected from the group consisting of LiFSI, LiTFSI, LiOTf, LiClO₄, LiBF₄, LIDFOB, and LiPF₆.
Embodiment 39: The method of embodiment 36 and embodiment 37, wherein the sodium ion salt is NaFSI, NaTFSI, NaOTf, NaClO₄, NaBF₄, NaBH₄, NaDFOB, and NaPF₆.
Embodiment 40: The method of embodiment 37 and embodiment 38, wherein the lithium-ion salt is LiTFSI.
Embodiment 41: The method of any one of embodiments 36 to 40, wherein the coordinating ligand is an ether, a carbonate, a sulfoxide, a sulfone, an amide, a sulfonamide, a phosphoramide, or combinations thereof.
Embodiment 42: The method of embodiment 41, wherein the ether is 1,2-dimethoxy ethane (DME).
Embodiment 43: The method of embodiment 41, wherein the ether is a glyme of Formula II:

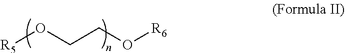

wherein,
R₇ and R₈ are independent selected from a substituted or unsubstituted alky, a substituted or unsubstituted aryl, a substituted or unsubstituted haloalkyl, a substituted or unsubstituted haloaryl, or combinations thereof, and
n is 1, 2, 3, or 4.
Embodiment 44: The method of any one of embodiments 36 to 43, wherein the zwitterionic polymer is poly(sulfobetaine methacrylate)(PSBMA).
Embodiment 45: The method of any one of embodiments 36 to 44, wherein the separator can be porous, particulate, fiber, or woven from electronically insulating materials further comprising a glass, a ceramic, or a polymer material.
Embodiment 46: The method of any one of embodiments 36 to 45, wherein the supramolecular building unit according to Formula I is:

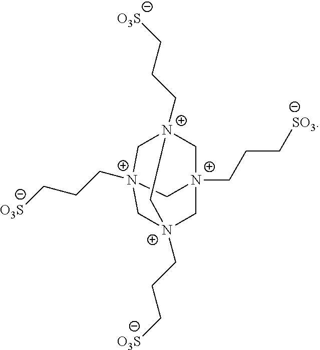

Embodiment 47: The method of any one of embodiments 36 to 46, wherein the viscoelastic liquid is a supramolecular organo-ionic electrolyte.
Embodiment 48: A method of deconstructing the all-solid-state electrochemical metal cell of any one of embodiments 30 to 35, comprising submerging the organo-ionic conductor in a solvent, dissolving the organo-ionic conductor, and isolating the supramolecular organo-ionic electrolyte from cathode active material thereby leaving a deconstructed cathode active material wherein the deconstructed cathode active material is free of the supramolecular organo-ionic electrolyte.
Embodiment 49: The method of embodiment 48, wherein the solvent is an ether.
Embodiment 50: The method of embodiment 49, wherein the ether is 1,2-dimethoxyethane (DME).
Embodiment 51: The method of any one of embodiments 48 to 50, wherein the anode active material and the deconstructed cathode active material can be reused to make a recycled all-solid-state electrochemical metal cell.
Embodiment 52: The method of embodiment 51, wherein the recycled all-solid-state electrochemical metal cell can recover at least 90% of the initial capacity of its components.
Embodiment 53: The method of embodiment 51 and embodiment 52, wherein the recycled all-solid-state electrochemical metal cell can retain at least 80% capacity for 100 cycles.
Embodiment 54: The method of any one of embodiments 48 to 53, wherein the all-solid-state electrochemical metal cell can be recycled 1, 2, 3, 4, or 5 times.

### EXAMPLES

### Example 1: Materials and Methods

### Preparation of Organo-Ionic (ORION) Conductors

Organo-ionic (ORION) powder was prepared in an argon glove box. A supramolecular building unit (SBU), lithium bis(trifluoromethanesulfonyl)imide (LiTFSI), and 1,2-dimethoxyethane (DME) were mixed with a ratio of SO₃⁻:Li⁺:DME=1:1:1, 1:2:2, and 1:4:4 for ORION 1:1, ORION 1:2, and ORION 1:4, respectively. Poly(sulfobetaine methacrylate)s (PSBMA) was then added to the mixture with an amount corresponding to 5 weight % of SBU. All of the mixture was ground by mortar, turning the mixture into a yellowish paste. After aging for 2 days in a glass vial in an argon glove box, the mixture solidified. The solid powder was ground by mortar again, and a fine white powder of ORION was obtained.

### Materials Characterization

Differential scanning calorimetry (DSC) was performed using TA Instrument DSC 2500 (New Castle, DE). A set of T-zero hermetic pan and the T-zero press was first transferred into a glove box filled with argon. The pan was tared, and an aliquot of the sample was weighed inside the pan. Then, the pan was pressed and transferred to the autosampler of the instrument, which was equilibrated at −90° C. After 5 min of isotherm, the temperature was ramped at 10° C. min⁻¹ to 90° C. and held for an additional 5 min before ramping back to −90° C. The same cycle was repeated five times. The second cycle was reported when no apparent difference was seen in cycles 2 to 6. X-ray crystallography (XRD) was conducted using a Rigaku MiniFlex 6G X-ray diffractometer (Tokyo, Japan), operated with a Cu Kα radiation with 600 W of X-ray source at 40 kV and 15 mA. To avoid exposure of ORION to ambient air, particularly moisture, the XRD samples were prepared in an argon glove box, where 10 to 20 mg of ORION was sealed in an air-tight holder with a beryllium window. 1H nuclear magnetic resonance (NMR) was performed using a Bruker Avance 500 NMR spectrometer (Billerica MA). Deuterium oxide was used as the solvent.

### Electrochemical Characterization

Electrochemical studies were performed using CR2032 coin cells. The conductivity and impedance were measured by BioLogic VMP3 (Seyssinet-pariset, France) in an environmental chamber for temperature control. Li symmetric cell test, Li|ORION|LFP (lithium iron phosphate) and Li|ORION|NMC (nickel manganese cobalt) cell test were carried out in an oven at 45° C. For the critical current density test, Li symmetric cells were allowed to rest for 12 hours; then, three formation cycles of 0.10 mA cm⁻² for 5 hours and rest for 2 hours were applied. The critical current density was measured with 2 hours of plating and 2 hours of rest starting from 0.10 mA cm⁻² with intervals of 0.05 mA cm⁻². Li symmetric cycling performance was conducted under 0.10 mA cm⁻² for 1 hour per step. For the linear sweep voltammetry test, Li|ORION|stainless steel cells were assembled in a coin cell. Then, voltage was swept from open circuit voltage to 5 V versus Li/Li⁺ with a scan rate of 0.1 mVs 1. Lithium iron phosphate (LFP) and nickel manganese cobalt (NMC) cathodes were prepared by slurry coating on an aluminum current collector with 8:1:1 ratio of active material:Super P:polyvinylidene fluoride in N-methyl-2-pyrrolidinone (NMP) solvent. The coated electrode was dried at 120° C. in vacuum. The active material loading was 1.0 to 1.2 mg cm⁻². For the cycling performance, the Li|ORION|LFP cell was tested under a current density of either 0.05 or 0.1 mA cm⁻², while 0.04 mA cm⁻² was used for the recycling test. The Li|ORION|NMC cell used a current density of 0.2 mA cm⁻². For all the cell tests, ORION powder was pressed with a polyethylene terephthalate (PET) mesh that turned into a pellet of ORION. The PET mesh was about 0.3 mm with 50% porosity.

### Synchrotron Hard X-Ray Microtomography

Li|ORION|NMC cells were assembled and sealed in Al-laminated pouches in an argon glove box. For the heat-treated cell, a pouch was heat-treated in a vacuum oven at 100° C. overnight. Monochromatic hard X-ray (23 keV) microtomography was then carried out on beamline 8.3.2 at the Advanced Light Source at Lawrence Berkeley National Laboratory (Berkeley, CA). The samples were rotated 180° under the X-ray, and the shadows cast by the samples were converted to image stacks with ˜1104 images in each stack. The stacks were resliced with ImageJ software (developed at the National Institutes of Health and the Laboratory of Optical and Computational Instrumentation) to obtain an aligned image stack. Dragonfly software (developed and distributed by Object Research Systems (ORS)) was used to display three dimensionally from the image stack.

### Example 2: Synthesis of the Structural Building Unit and PSBMA

### Synthesis of 3,3′,3″,3′″-(1,3,5,7-tetraazaadamantane-1,3,5,7-tetraium-1,3,5,7-tetrayl)tetrakis(propane-1-sulfonate) (SBU)

To a 500 mL round-bottom flask, 9.6 g (60 mmol) of hexamethylenetetramine (Aldrich, 99%, St. Louis and Burlington, MA) was mixed with 29.3 g (240 mmol) of 1,3-propanesultone (TCI, 99%) and 240 mL of dry acetonitrile (solvent purification system). The waterless condenser connected to a flow of nitrogen was installed. The mixture was brought to reflux and stirred vigorously for 72 h. The product was collected by centrifuge at 4,400 rpm for 1 min. The product was washed with dimethylformamide twice and with diethyl ether three times. The solid was placed under high vacuum overnight to afford 16.45 g of off-white fine powder (64% yield).

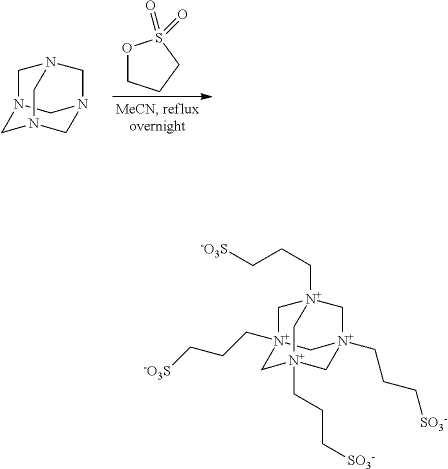

1H NMR (D₂O, 500 MHz): δ=5.06 (12H, s), 4.63 (5.8H, d, J=13.0 Hz), 4.49 (6.2H, dt, J=12.7, 0.7 Hz), 2.99 (3.9H, m), 2.86 (4.2H, m) 2.07 (3.9H, m) ppm.

### Synthesis of Poly(Sulfobetaine Methacrylate)(PSBMA)

3.00 g (10.7 mmol) of 2-(N-3-sulfopropyl-N,N-dimethyl ammonium)ethyl methacrylate (Aldrich, 95%, St. Louis and Burlington, MA) and 15.0 mg (53.5 μmol) of 4,4′-azobis(4-cyanovaleric acid) (Aldrich, 98%, St. Louis and Burlington, MA) were mixed in 3.0 mL of 2,2,2-trifluoroethanol (TCI, 99%) in a Schlenk flask. The mixture was degassed by nitrogen bubbling for 10 min. Then the mixture was stirred at 70° C. overnight. The viscous polymer solution was precipitated in acetonitrile to remove the unreacted monomer and yielded 2.85 g of white powder after filtration and solvent removal in vacuo overnight.

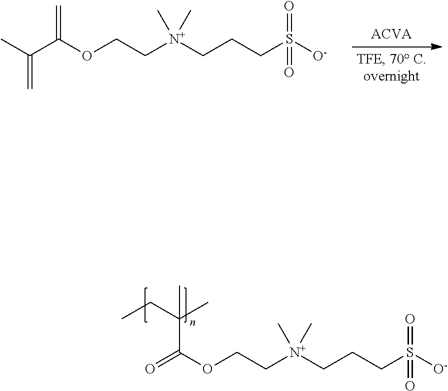

1H NMR (20 mg mL-1 NaCl in D₂O, 500 MHz): δ=4.6-4.1 (br, 2nH), 4.0-3.6 (br, 2nH), 3.6-3.4 (br, 2nH), 3.3-3.0 (br, 6nH), 3.0-2.7 (br, 2nH), 2.4-1.5 (br, 4nH), 1.3-0.5 (br, 3/H) ppm.

### Example 3: Physicochemical Properties of ORION Conductors

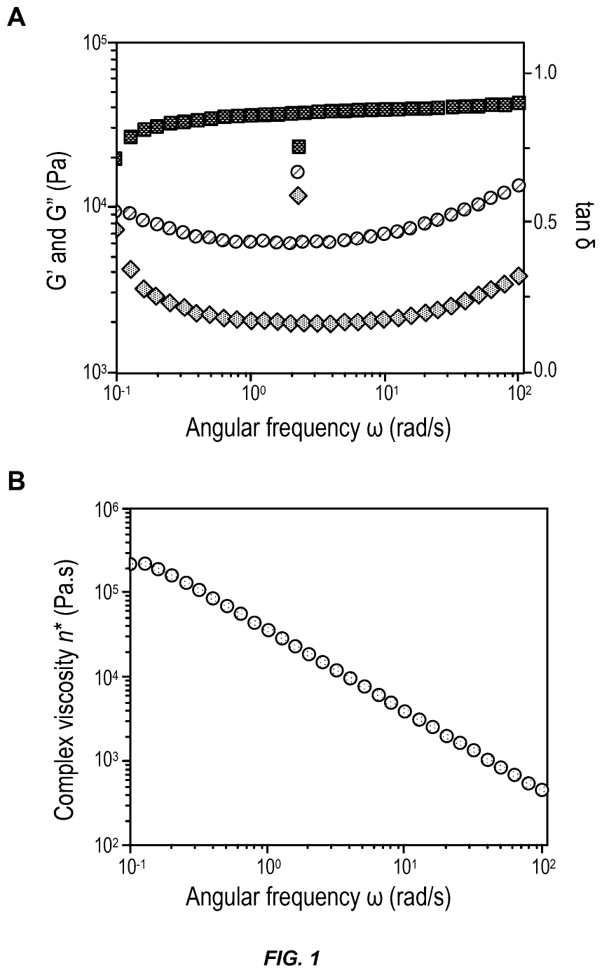

To create supramolecular ORION conductors, a tetrafunctional zwitterionic SBU was synthesized via ring opening of propane sultone with hexamethylenetetramine. The zwitterionic SBU was ball-milled with various lithium salts, such as lithium bis(trifluoromethanesulfonyl)imide (LiTFSI), noting that across a range of molar ratios of SO₃⁻:Li⁺, the materials generated were glassy, brittle, and difficult to process thermally, consistent with highly networked material, but undesirable network dynamics. To decrease the Li coordination number likely responsible for this behavior, LiTFSI was replaced with Li(DME)TFSI, i.e., its crystalline solvate with 1,2-dimethoxyethane (DME). At molar ratios of SO₃⁻:Li⁺ of 1:x, where x=1 to 4, malleable solids were obtained with excellent processability at remarkably low temperatures, typically below 100° C. For x exceeding 4, brittle solids were obtained because of an overabundance of Li(DME)TFSI crystals and phase separation. To manipulate the viscosity of these materials in the liquidus state, poly(sulfobetaine methacrylate)s (PSBMA) was used. PSBMA was prepared using free radical polymerization. As a result, viscoelastic solids were obtained at the temperature of 45° C., where electrochemical performance was evaluated (FIG. 1). Not intending to be bound by theory, these initial observations during synthesis suggested notably complex behavior at the molecular scale translating to bulk materials properties.

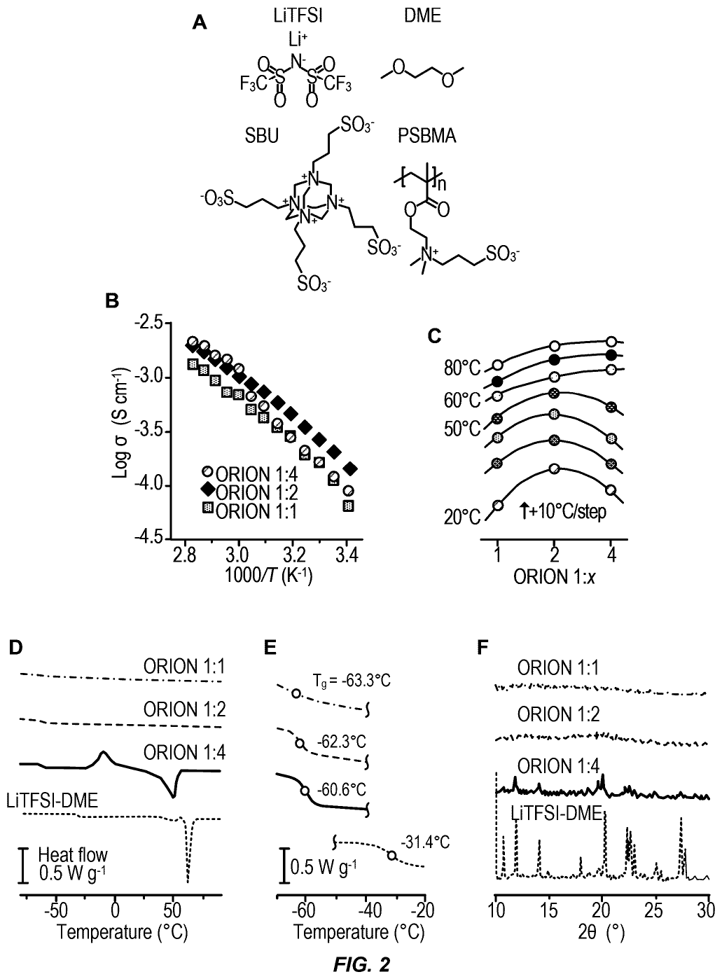

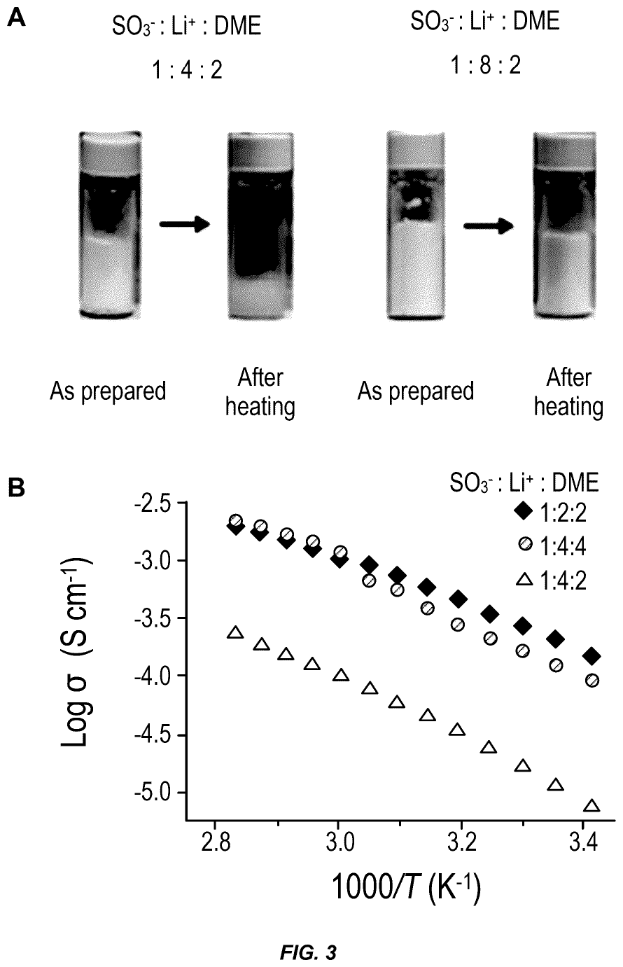

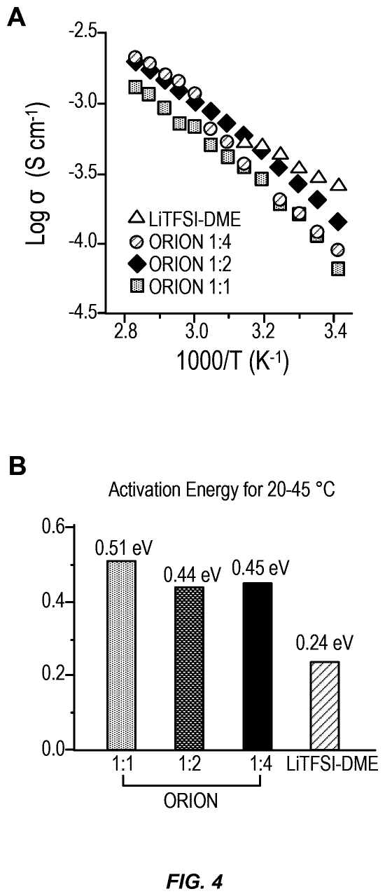

To understand the implications of these behaviors on structure-transport properties of the materials, a series of ORION conductors were prepared with varying ratios of SBU to Li(DME)TFSI, keeping the portion of PSBMA fixed at 5% (w/w) relative to the SBU (FIG. 2A); SO₃⁻:Li⁺ ratios of 1:1, 1:2, and 1:4 were considered, as these produced thermally processable solid-ion conductors. Their ionic conductivities were measured over a temperature range of T=20° C. to 80° C. (FIG. 2B) by using electrochemical impedance spectroscopy (EIS) for samples thermally annealed between blocking stainless steel electrodes. Overall, ORION 1:2 demonstrated the highest conductivity: for example, σ=0.58 mS cm-1 for ORION 1:2 at 45° C., compared to 0.34 mS cm⁻¹ for ORION 1:1 and 0.38 mS cm⁻¹ for ORION 1:4. An abrupt increase in ionic conductivity was observed on heating ORION 1:4 from 50° C. to 60° C., suggesting a possible phase transition in the material (FIG. 2C). Nonetheless, ORION 1:2 demonstrated the highest conductivity over the temperature region of interest for SSBs (i.e., from 20° C. to 55° C.), which is comparable or higher than reported polymer or zwitterionic solid electrolytes. When only the LiTFSI ratios were increased, inhomogeneous mixtures were observed with a substantial drop in terms of conductivity, suggesting that ORION 1:2 fully used solvation sites (FIG. 3). The activation energy for ORION 1:2 was about 0.44 eV, which confirmed that ion conduction was not from liquid LiTFSI-DME (0.24 eV; FIG. 4).

To provide a deeper understanding of the thermal properties of ORION conductors from the perspective of their phase transitions, differential scanning calorimetry (DSC) over a temperature range of −80° C. to 90° C. was carried out (FIG. 2D and FIG. 2E). Li(DME)TFSI exhibited a melting point of ˜62° C. For ORION conductors with 1:1 and 1:2 ratios of SO₃⁻:Li⁺, complete dissolution of the Li(DME) TFSI solvate crystal into the SBU was observed, such that there were no longer observable melting transitions and instead only glass transitions of T_{g}=−63° C. and −62° C., respectively. At the highest loading of Li(DME) TFSI in the ORION conductor, a melting transition at 50° C. was observed, as well as cold crystallization behavior at −10° C.; both characteristics are exclusive to ORION 1:4. Not intending to be bound by theory, this could indicate that ORION 1:4 is overloaded with Li(DME)TFSI and that small crystallites with a lower-than-bulk melting temperature persist in the material. Accordingly, the increase in ionic conductivity above 50° C. could be related to the melting of said crystallites, which produced more mobile ionic charge carriers than were available at lower temperatures.

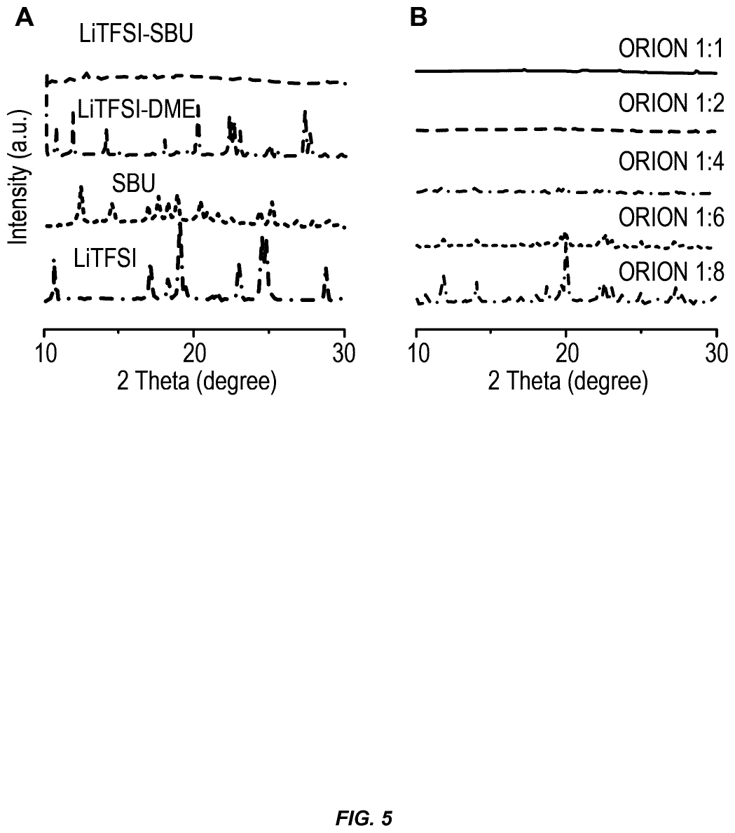

Not intending to be bound by theory, the ORION conductors may be able to network Li(DME)TFSI into viscoelastic solid-ion conductors, whose processability and conductivity benefit from improved network dynamics tied to DME and its role in modifying the Li coordination chemistry. However, there could be an upper bound above which Li(DME)TFSI can be incorporated without also incurring the formation of crystal-in-glass composites. This is further supported by the powder X-ray diffraction (PXRD; FIG. 2F). Whereas the crystallinity of Li(DME)TFSI completely subsided in ORION 1:1 and 1:2, it rose in ORION 1:4, concurrent with the amorphous phase. Not intending to be bound by theory, this behavior could be driven by strong interactions between Li⁺ and SO₃⁻, as seen in the amorphization of LiTFSI when the SBU is present and DME is absent (FIG. 5).

### Example 4: Solid Solvation of Lithium Ions in ORION Conductors

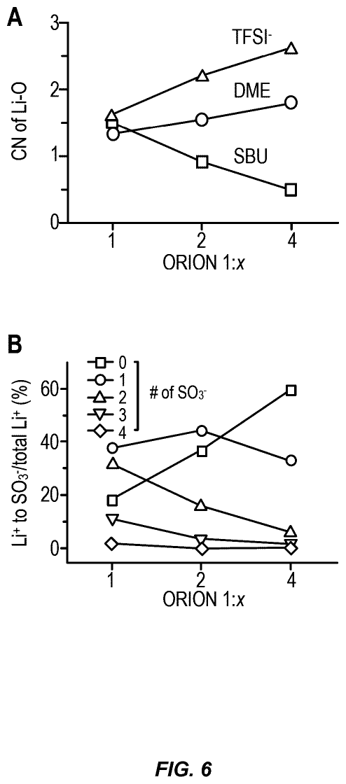

To understand how lithium salts were distributed in ORION conductors molecular dynamics (MD) simulations for ORION 1:1, 1:2, and 1:4 materials were conducted (FIG. 6). Notably, in the condensed phase, sulfonate end groups of the SBU were more strongly coordinating to Li⁺ than DME or TFSI⁻, as evidenced in the changes in coordination number at different Li⁺:SO₃⁻ ratios (FIG. 6A).

### Computation Methods

Classical MD simulations were performed for the ORION electrolytes with different SO₃⁻ (in SBU) to LiTFSI and DME concentrations (ORION 1:1, ORION 1:2, ORION 1:4) using the LAMMPS (Large Scale Atomic/Molecular Massively Parallel Simulator) package (developed at the Sandia National Laboratories, Temple University).

The bonded and un-bonded parameters were obtained from OPLS-AA (Optimized Potentials for Liquid Simulations All Atom, developed by Prof. William L. Jorgensen at Purdue University) force fields using LigParGen web server (Yale University) while TFSI⁻ and Li⁺ force fields were taken from Lopes et al. and Jensen et al. respectively with a 0.8 scaling in charge. A cutoff distance of 1.5 nm was chosen for the 12-6 Lennard-Jones interactions. The long-range electrostatic interactions were handled by the particle-particle particle-mesh (pppm) solver with a grid spacing of 0.1 nm.

The initial simulation boxes were constructed by randomly packed molecules in a sufficiently large cubic box using Packmol software (originally developed by J. M. Martinez and L. Martinez at the State University of Campinas, Brazil). SBU, as the largest molecule in the ORION systems, were fixed at the number of 27 (3×3×3) in each of simulation box. Smaller components like LiTFSI and DME were then added according to the desired molarity. For example, in terms of ORION 1:1, there are 27 SBU, 108 LiTFSI and 108 DME in a simulation box. The ORION 1:1, ORION 1:2, ORION 1:4 systems contain a total number of 5,454 atoms, 8,910 atoms and 15,822 atoms, respectively. The initial guess of simulation box was determined by the SBU size and total atom number.

A time step of 1 fs was selected for MD runs. The completed processes for each of the simulation box was: (i) an initial conjugated-gradient energy minimization process with a convergence criterion of 10-4; (ii) isothermal-isobaric ensemble (NpT) simulations at room-temperature (298 K) and the pressure of 1 atm for 3 ns to obtain the correct volume; (iii) an annealing process for all the systems to melt and to avoid local configuration confinement. (298 K to 400 K for 1 ns, 400 K to 400 K for 2 ns, 400 K to 298 K for 2 ns); (iv) canonical ensemble (NVT) simulation at 298 K for 5 ns equilibrium and an additional 10 ns of snapshots for coordination number (CN) and radial distribution function (RDF) computing (see FIG. 6A and FIG. 3). For each of the ORION ratio, 3 duplicated MD runs with distinct initial simulation boxes were performed to get a reliable averaged coordination numbers of Li—O from SBU, DME and TFSI-. The simulated densities were close for three ratios after NpT convergence: 1.58 g cm⁻³ for ORION 1:1; 1.61 g cm⁻³ for ORION 1:2 and 1.60 g cm⁻³ for ORION 1:4. MDAnalysis (Austin, TX) package was used for the network architecture analysis on Li⁺ ions, sulfonate (SO₃⁻) groups and N4-N4 cage distances.

### MD Simulations

For ORION 1:1, the SBU sulfonates appear to be predominantly coordinated to 82% of the desolvated Li⁺ ions. In addition, 45% of the desolvated Li⁺ ions appear to bridge neighboring SBUs, forming a dense supramolecular network. The percentage of desolvated Li⁺ ions categorized by numbers of neighboring sulfonates are depicted in FIG. 6B and Table 1.

TABLE 1
The Li percentage coordinated with 0SO₃⁻,
1SO₃⁻, 2SO₃⁻, 3SO₃⁻, 4SO₃⁻ (very
rare) for ORION 1:x (x = 1, 2, 4). The
data was computed from MD simulation snapshots.

| | Total | |
|---|---|---|
| ORION | number of | Number of SO₃⁻ |

| Systems | Li | 0 | 1 | 2 | 3 | 4 |
|---|---|---|---|---|---|---|
| ORION | 108 | 18% | 37% | 32% | 11% | 2% |
| 1:1 | | | | | | |
| ORION | 216 | 37% | 44% | 16% | 3% | 0% |
| 1:2 | | | | | | |
| ORION | 432 | 60% | 33% | 6% | 1% | 0% |
| 1:4 | | | | | | |

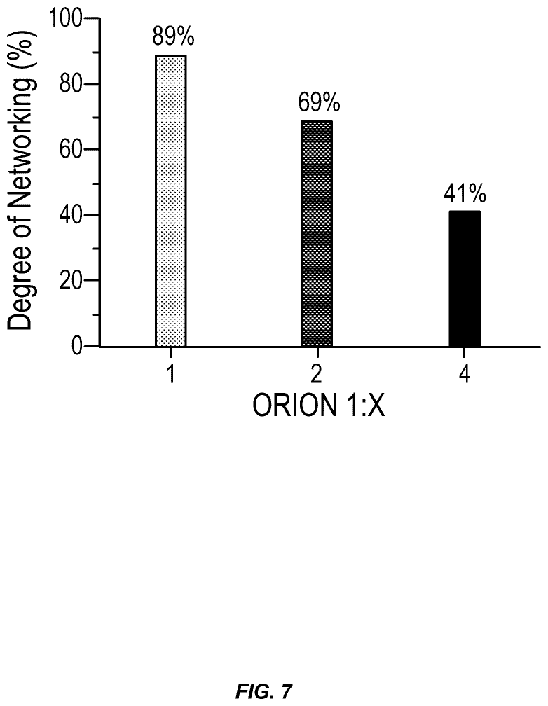

Based on MD simulation results, free DME in ORION 1:1 material segregates to the tetraalkylammonium core of the SBU with short O—H bond distances (2.3 to 2.8 A). Not intending to be bound by theory, this suggests that hydrogen bonding may dictate that behavior. Together, the simulations suggest that zwitterionic SBUs provide an effective solid-solvation environment for Li(DME)TFSI in ORION 1:1 materials, promoting the formation of a highly networked brittle and glassy solid, evidenced by a high degree of networking of 89% (see FIG. 7), where degree of networking was calculated by Equation 1:

$$Degree of networking = \qquad ( Equation 1 )$$

$$\frac{The number of connected {SO}_{3}^{-} groups}{The number of total {SO}_{3}^{-} groups} \times 100 \% .$$

For ORION 1:1, the number of connected SO₃⁻ groups was determined to be 96 while the number of total SO₃⁻ groups was 108 (i.e., 89%).

In ORION 1:2 materials, a supramolecular network was also observed, consisting of desolvated Li⁺ ions bridging neighboring SBUs through coordination to their sulfonates. Compared to ORION 1:1 materials, ORION 1:2 materials exhibited a lower degree of networking (69% for ORION 1:2 versus 89% for ORION 1:1; FIG. 7). Applying Equation 1, for ORION 1:2, the number of connected SO₃⁻ groups was determined to be 74 while the number of total SO₃⁻ groups was 108 (i.e., 69%). Free DME also engaged in hydrogen bonding to the SBU, as was the case with ORION 1:1. Solid solvation and speciation of Li⁺ in ORION 1:2 materials were notably more complex: For example, network terminations were observed, consisting of 44% of Li⁺ bound to only one sulfonate, with the remaining coordination sites taken up by DME and TFSI⁻; also, 37% of Li⁺ appeared to be unbound from the sulfonates (FIG. 6B and Table 1). Not intending to be bound by theory, these new species may be responsible for the higher ionic conductivity, along with gains coming from lower network density. In the case of free TFSI⁻, they also appear to form hydrogen bonds with the core of the SBU and C—H bonds in the pendants, particularly those adjacent to the sulfonate and tetraalkylammonium core. Not intending to be bound by theory, such interactions may stretch the sulfonate arms, contributing to the segmental movement, which may improve Li⁺ ionic conduction. While DME prefers to be coordinated only with Li⁺ ions and the core of the SBU, TFSI⁻ exhibits unbiased interactions with all the molecules including Li⁺ ions. Not intending to be bound by theory, this suggests that DME may play a role as a mediator in the supramolecular system.

In stark contrast, for ORION 1:4 materials, SBUs interacting with Li⁺ were largely isolated or exhibited only short-range clustering behavior (Table 2); there appeared to be little network formation.

TABLE 2
The volume of simulation boxes for MD runs and the distances
between N4-N4 cages, computed from MD snapshots.

| | Distance between N4-N4 cage (Å) | | | |
|---|---|---|---|---|
| ORION systems | Mean | Max | Min | Volume (Å) |
| ORION 1:1 | 24.4 | 46.1 | 8.4 | 60607 |
| ORION 1:2 | 29.1 | 56.2 | 9.4 | 101274 |
| ORION 1:4 | 36.6 | 71.8 | 10.5 | 186367 |

The degree of networking was reduced to 41% (FIG. 7), and 60% of Li⁺ ions did not appear to bind to any of the available sulfonates, while those that did (33%) appear to form as network terminations (FIG. 6B). Applying Equation 1, for ORION 1:4, the number of connected SO₃⁻ groups was determined to be 44 while the number of total SO₃⁻ groups was 108 (i.e., 41%) Moreover, there appeared to be insufficient numbers of sulfonate groups to associate with all of the available Li(DME)TFSI: Most of the SBU sulfonates were already bounded with at least one Li⁺ ion nearby (see Table 3). What remained of Li(DME)TFSI, unassociated with the SBUs, appeared to also exhibit crystallinity but less than might otherwise be expected, suggesting that SBU suppressed crystallization of the solvate. These simulation results were consistent with our DSC and PXRD data (FIG. 2). Surprisingly, the architectural features in ORION conductors create unique coordination environments for facilitating ion conduction pathways, processability, interface and interphase creation, and resilience to volume changes in all solid-state cells.

TABLE 3
The percentage of sulfonate groups (SO₃⁻) that
are coordinated with 0Li⁺, 1Li⁺, 2Li⁺, 3Li⁺
for ORION 1:x (x = 1, 2, 4) systems. The data
are computed from MD simulation snapshots.

| | Total number | Number of Li⁺ | | | |
|---|---|---|---|---|---|
| ORION systems | of SO₃⁻ groups | 0 | 1 | 2 | 3 |
| ORION 1:1 | 108 | 17% | 42% | 32% | 9% |
| ORION 1:2 | 108 | 3% | 35% | 48% | 14% |
| ORION 1:4 | 108 | 2% | 17% | 65% | 17% |

### Example 5: Ion Transport in ORION Solid Electrolytes

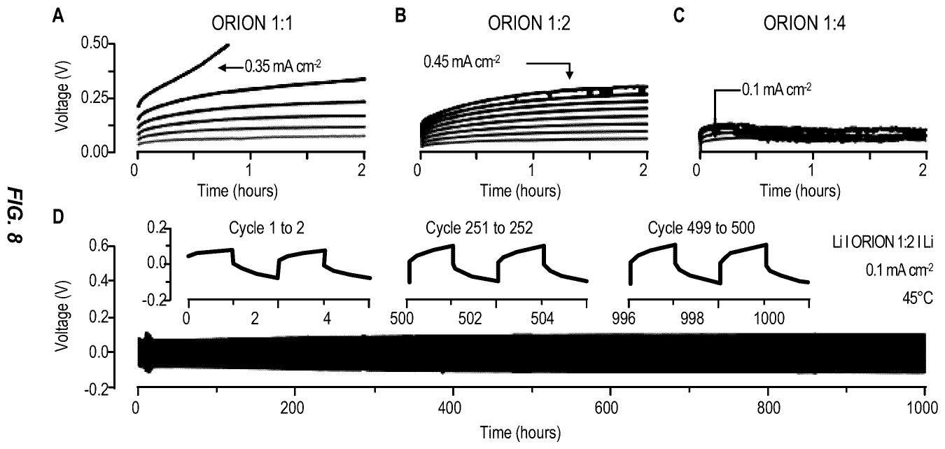

Chemomechanical properties of solid-ion conductors dictate their behaviors as solid electrolytes in batteries and other electrochemical devices, particularly for devices featuring metal anodes undergoing reversible plating and stripping. As noted in the Examples above, ORION conductors feature, to varying degrees, both structural and mobile Li⁺, depending on the ratio of Li⁺:SO₃⁻. To understand how solid solvation and Li⁺ speciation affects their transport properties, the critical current density at 45° C. in Li—Li symmetric cells assembled with ORION 1:1, 1:2, and 1:4 conductors as solid electrolytes was determined (FIG. 8, A to C). ORION 1:1 solid electrolytes exhibited the highest overpotentials by comparison to ORION 1:2 and 1:4 materials for lithium metal plating (and stripping) at a given current density. Divergences in overpotential with time, allowed quantification of the critical current density of ORION 1:1 solid electrolytes as 0.30 mA cm⁻² (FIG. 8A). For ORION 1:2, solid electrolytes, which showed the highest ionic conductivity (FIG. 2B), demonstrated improved Li⁺ plating and stripping behaviors with lower overpotentials and a critical current density of 0.40 mA cm⁻² (FIG. 8B). ORION 1:4 solid electrolytes, which are crystal-in-glass composites, initially evidenced large overpotentials for lithium plating/stripping and lastly soft short-circuiting, even at the lowest current density tested (0.10 mA cm⁻²; FIG. 8C). Not intending to be bound by theory, the high performance of ORION 1:2 could be attributed to favorable solvation environments, especially majority of Li ions bound to only one sulfonate, as well as the well-formed network, harnessing chemomechanical properties for both ion transport and mechanical integrity.

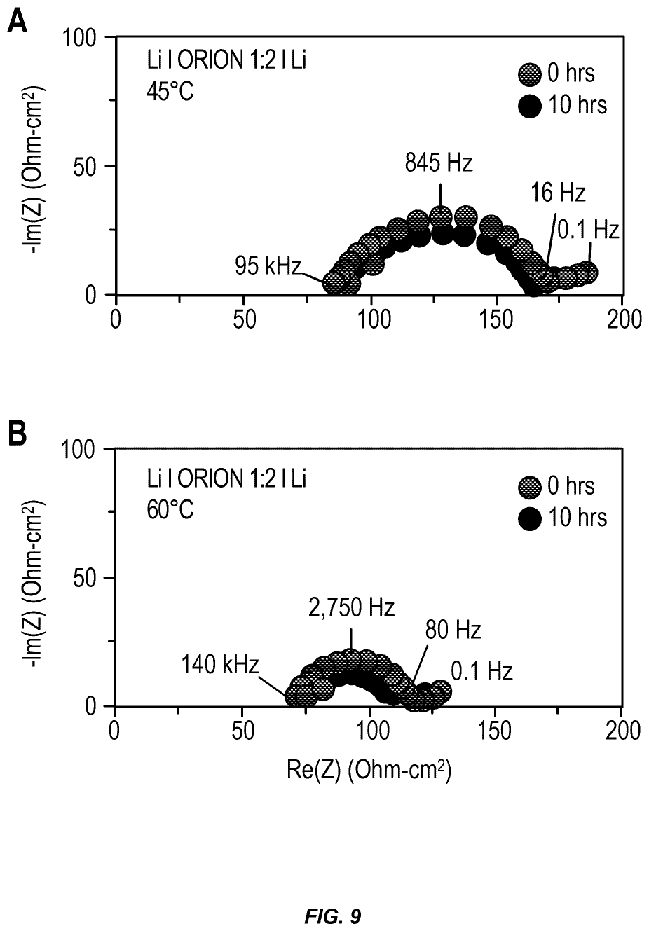

With ORION 1:2, long-term cycling behavior for lithium plating and stripping in a Li—Li symmetric cell at 45° C. was further investigated (FIG. 8D). With a current density of 0.10 mA cm⁻², which is below the critical current density, ORION 1:2 solid electrolytes demonstrated stable cycling performance for 1000 hours (i.e., 500 cycles consisting of an alternating sequence of plating and stripping, each for a duration of 1 hour). The enlarged voltage profiles show that the overpotential slightly increased after 500 cycles, but the voltage plateaus were stable without divergence, where neither dendrites nor kinetic limitation were observed (FIG. 8D, inset). Not intending to be bound by theory, this suggests that the interphase generated between ORION 1:2 solid ion conductors and lithium metal is relatively stable over time. EIS of the symmetric cells over time was thus conducted at both 45° C. and 60° C., where the salient features were largely unchanged over a period of 10 hours (FIG. 9).

### Example 6: Solid-State Battery Performance and Closed-Loop Cathode Recycling

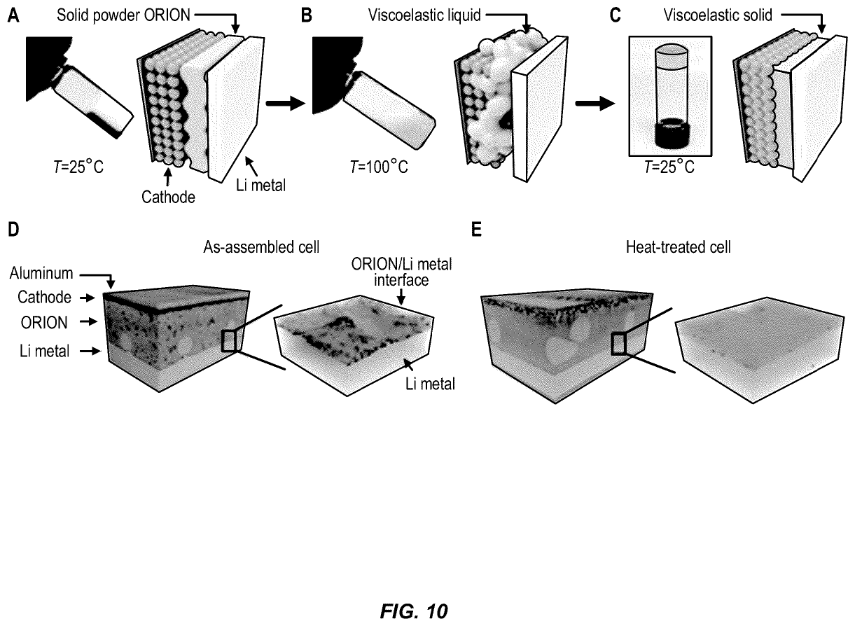

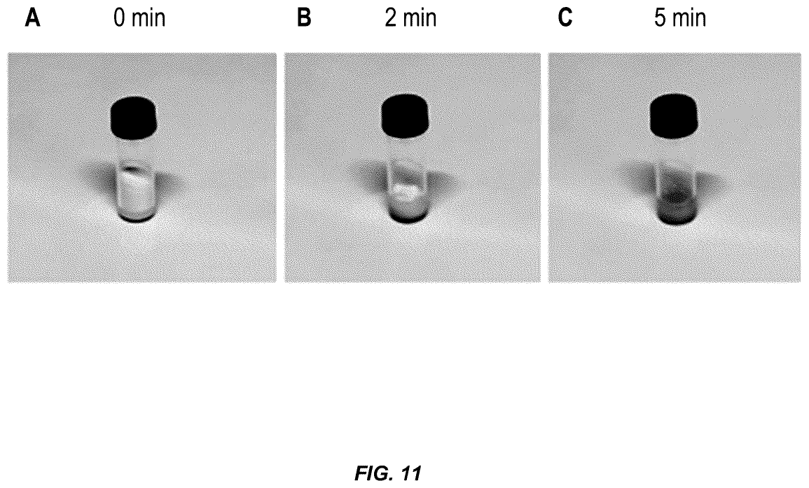

Creating conformal interfaces in SSBs during battery assembly remains a challenge, owing to the hardness of constituent materials. Viscoelastic ion conductors, particularly those with a low temperature transition between solid and liquidus states, could maximize the interfacial area between the electrode and electrolyte materials. To do this, the supramolecular ORION solid electrolyte would have to favorably wet the anode, cathode, and separator. In this example, conventional slurry-coated cathodes were melt-infiltrated with the ORION 1:2 solid electrolyte by introducing ball-milled ORION 1:2 solid powders (FIG. 10A) to all-solid-state lithium metal cells, raising the temperature of the cell to 100° C. for 5 min (FIG. 10B and FIG. 11) and allowing the cell to cool to ambient temperature to solidify the electrolyte (FIG. 10C). Synchrotron hard X-ray tomography was carried out in cells as assembled and after thermal annealing to characterize changes and the extent of interfacial coherence at lithium metal and within the pores of the cathode and separator (in this example, a woven mesh comprising polyethylene terephthalate (PET); FIGS. 10, D and E).

As assembled, the ball-milled ORION 1:2 solid electrolyte (not yet been thermally annealed) showed a dispersion of Li(DME)TFSI crystallites that manifested in the tomogram with highly contrasting features (FIG. 10D). The interface between Li metal and ball-milled ORION 1:2 materials was also rough (FIG. 10D, enlarged region). After 5 min at 100° C., Li(DME)TFSI crystallites were completely dissolved into the matrix comprising the zwitterionic SBU and polymeric viscosity modifier (FIG. 10E). The in situ formation of ORION 1:2 solid electrolyte and its infiltration into the separator and cathode produced a conformal interface at lithium metal (FIG. 10E, enlarged region) and the separator, whose weave was observed in cross section with no apparent aberrations in the interface with ORION 1:2 solid electrolytes. The evolution in contrast from dark (empty pores) to light (ORION-filled pores) in the tomogram and throughout the porous cathode provided further insight into the extent of cathode infiltration. Taken together, but not intending to be bound by theory, all solid-state ORION-infiltrated lithium metal cells should exhibit reversible cycling behavior, as all active materials necessary for cell cycling are in contact with the solid electrolyte after thermal annealing.

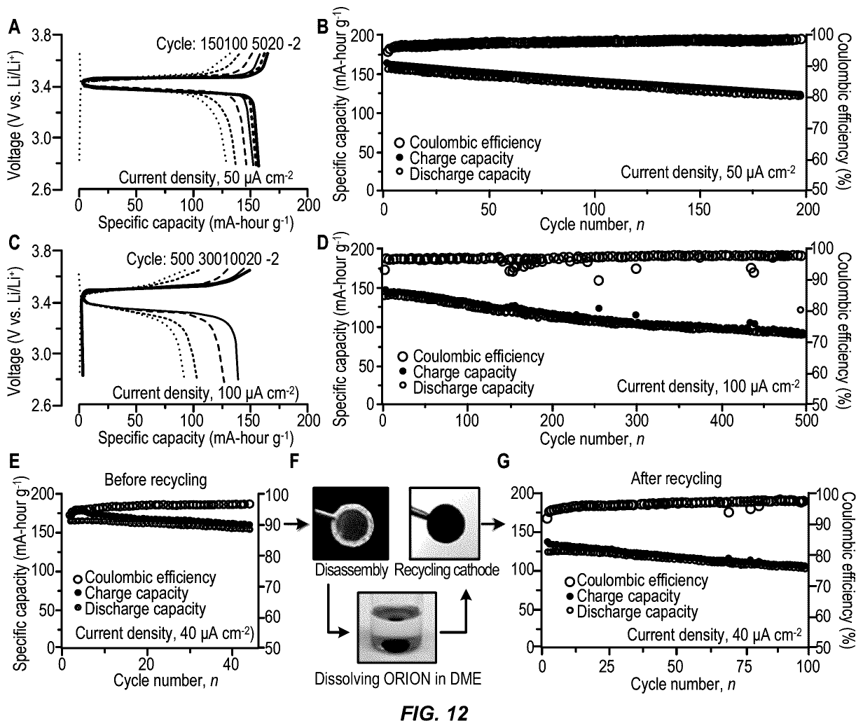

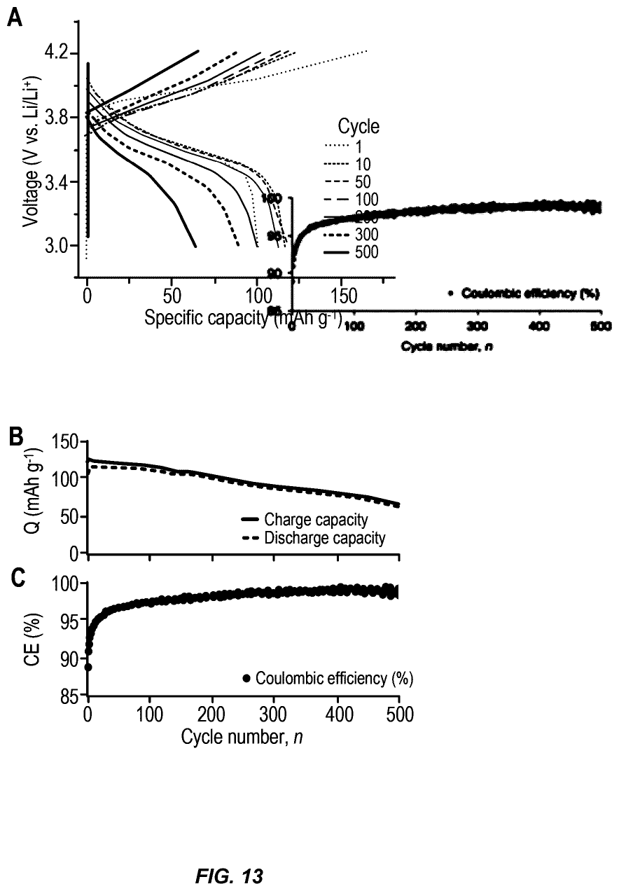

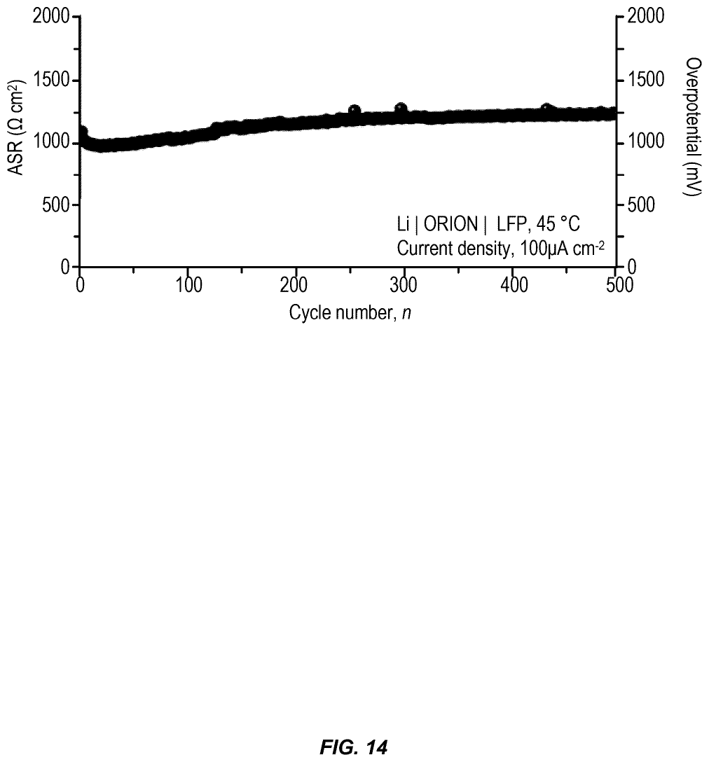

To understand how establishing conformal interfaces affects all solid SSB performance with ORION 1:2 materials in place, Li|ORION|LFP cells were cycled at a current density of either 50 μA cm⁻² (FIGS. 12, A and B) or 100 μA cm⁻² (FIGS. 12, C and D), which are ˜0.25° C. and 0.5 C (1 C=150 mA g⁻¹), respectively. Both cells achieved a specific capacity close to the theoretical capacity of LFP. Cells cycled at a current density of 50 μA cm⁻² retained 85% capacity after 100 cycles, while those cycled at 100 μA cm⁻² retained 82% capacity over the same period. Coulombic efficiency in both cases was higher than 98%. The voltage stability window of ORION 1:2 ion conductors was also tested and the cycling performance in Li|ORION|LiNMC532 all-solid-state cells was reversibly cycled at a current density of 200 μA cm⁻², where after 500 cycles, the cells retained a Coulombic efficiency higher than 99% after 500 cycles (FIG. 13); no shorting behavior was observed. Together, and not intending to be bound by theory, these data indicate that ORION conductors are versatile in their ability to exploit a low temperature solid-liquid phase transformation and favorable wetting characteristics to fabricate all-solid-state lithium metal cells that are rechargeable for hundreds of cycles. Owing to the remarkably slow area-specific resistance (ASR) rise over time (FIG. 14), the feasibility of deconstructing the all-solid-state cells was tested, taking advantage of the solubility of ORION conductors, and to close the loop in direct cathode recycling. ASR was calculated according to Equation 2:

$$ASR = \frac{\frac{{E}_{charge}}{{Q}_{charge}} - \frac{{E}_{discharge}}{{Q}_{discharge}}}{{I}_{charge} + {I}_{discharge}} \times A \qquad ( Equation 2 )$$

where E_{charge} is the charge energy (Wh), E_{discharge} is the discharge energy (Wh), Q_{charge} is the charge capacity (Ah), Q_{discharge} is the discharge capacity (Ah), A is the cathode area (cm²), I_{charge} is the charging current (A), and I_{discharge} is the discharging current (A). The overpotential (V) is calculated by ASR×100 μA cm⁻².

To demonstrate direct cathode recycling potential with Li|ORION|LFP (FIG. 12, E to G), it was cycled at a current density of 40 μA cm⁻² until the capacity retention was ˜90% of the initial capacity (FIG. 12E). The cell was then disassembled and the LFP cathode was immersed in DME to dissolve the supramolecular solid ion conductor (FIG. 12F). This cathode was then reassembled into a recycled Li|ORION|LFP cell which was again subjected it to reversible cycling at 40 μA cm⁻² (FIG. 12G). The recycled ORION cell showed initial capacity of ˜90% compared to the capacity before direct cathode recycling. Not intending to be bound by theory, the lower capacity could be attributed to changes in mechanical integrity of the composite cathode, which could occur during disassembly. Notably, the recycled LFP cathode demonstrated 84% capacity retention after 100 cycles compared to the capacity of the second cycle of refurbished cell (assuming the first cycle was a formation cycle). The capacity fade rate before recycling was −0.14% per cycle (cycles 2 to 43 in FIG. 12E) while −0.19% per cycle (cycles 2 to 100 in FIG. 12G) after recycling. Thus, direct cathode recycling achieved similar long-term performance to the fade rate, capacity retention, and underlying Coulombic efficiency of a pristine LFP cathode (85% capacity retention from FIG. 12 (A and B)).

### Example 7: Na ORION Solid Electrolyte

### Synthesis of Na ORION Solid Electrolyte

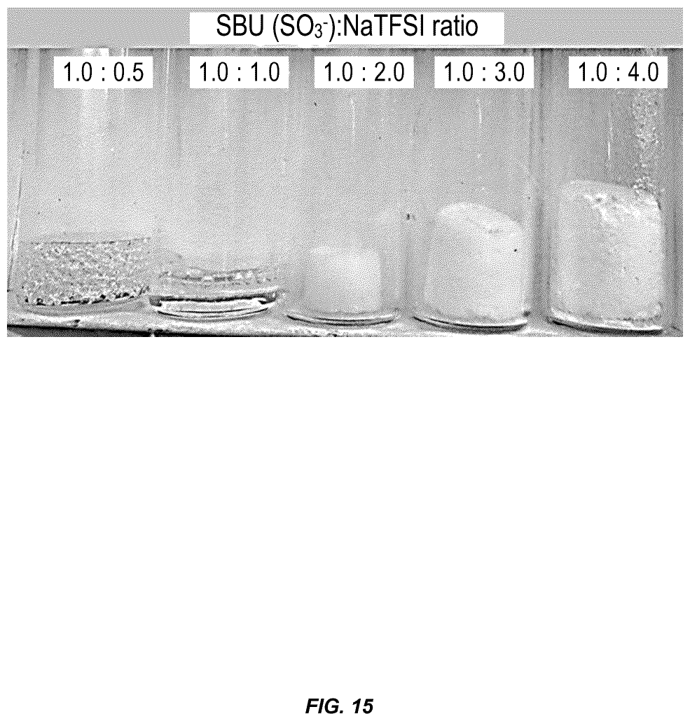

SBU and NaTFSI were ground together with a target ratio (SBU(SO₃⁻):NaTFSI=1.0:x, where x=0.5, 1.0, 2.0, 3.0, or 4.0). The ratio of SBU was based on SO₃⁻ ligand rather than molecular ratio. One SBU has four SO₃⁻ ligand yielding 0.25 mole ratio of SBU to SO₃⁻ ratio. The mixture was heated at 110° C. over 6 h using hot plate to make a yellow transparent glassy solid at (SO₃⁻):NaTFSI ratios of 1.0:0.5-1.0 and opaque crystal-in-glass composites at (SO₃⁻):NaTFSI ratios >1.0:1.0 (FIG. 15).

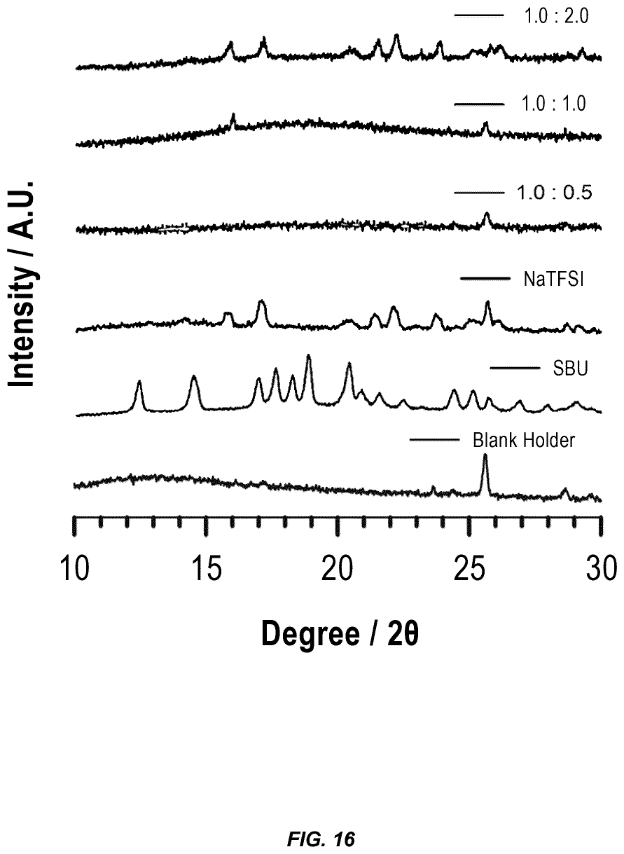

Crystallinity of precursors and Na ORION electrolytes were analyzed with X-ray powder diffraction (Rigaku Miniflex 6G, Tokyo, Japan). All samples were prepared and sealed in Argon (Ar) filled glovebox. XRD data shows the formation of crystal-in-glass composites where (SO₃⁻):NaTFSI ratios >1.0:1.0 (FIG. 16).

Synthesis of Na ORION Solid Electrolyte with Solvents

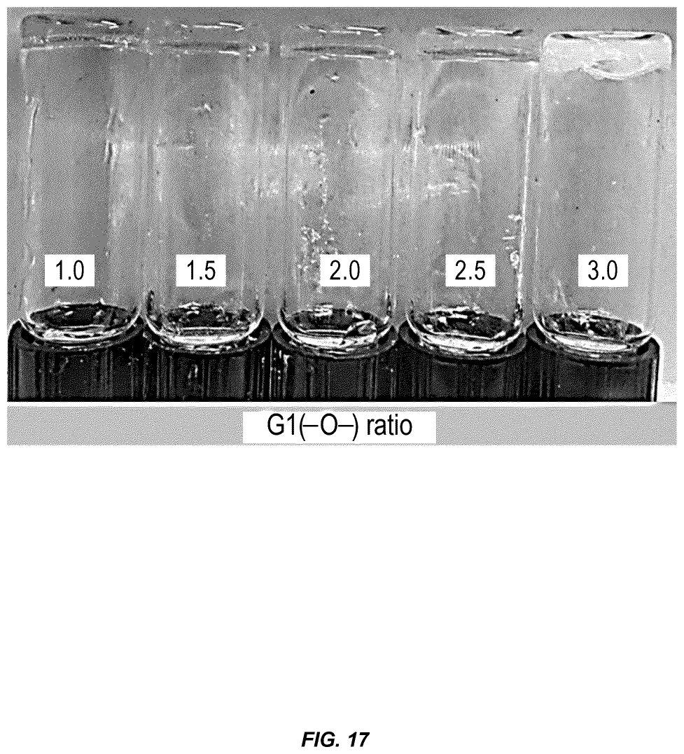

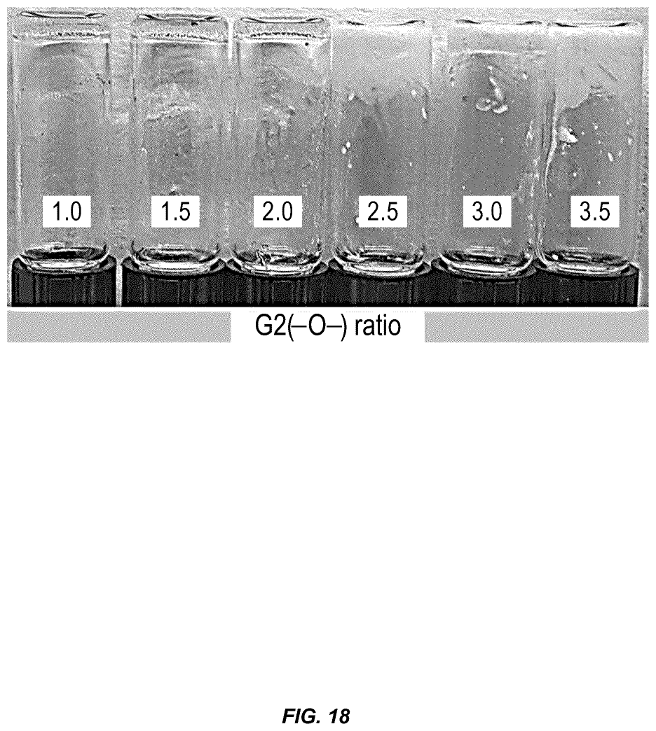

SBU and NaTFSI were ground together with a ratio of SBU(SO₃⁻):NaTFSI=1.0:1.0. DME or DEGDME was added to the powder mixture with a ratio of SBU(SO₃⁻):NaTFSI:solvent (—O—)=1.0:1.0:x, where x=1.0, 1.5, 2.0, 2.5, 3.0, or 3.5. The ratio of solvents was based on oxygen amount in solvent rather than molecular ratio. DME has two oxygen atoms and DEGDME has three oxygen atoms. The mixture was heated over 110° C. over 6 hours using a hot plate with stirring to make a yellow glassy product which became a crystal-in-glass composite where x=3.0 with DME (FIG. 17) and where x=2.5, 3.0, or 3.5 with DEGDME (FIG. 18).

### Thermal Analysis

Thermal property of Na ORION electrolytes were examined with differential scanning calorimetry experiments (DSC5000, TA Instruments, New Castle, DE). All samples were prepared in Argon (Ar) filled glovebox and sealed with Tzero hermetic lid and Tzero pan (Tzero, TA Instruments, New Castle, DE). The results were gained with 10° C. min⁻¹ heating rate from −80 to 120° C. T_{g} was calculated with Trios software (TA Instruments, New Castle, DE).

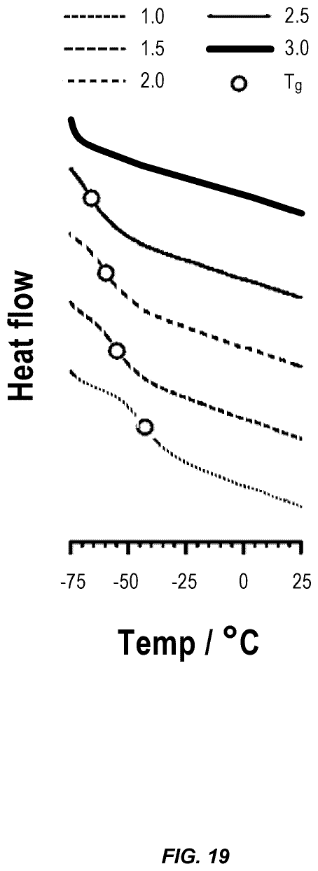

FIG. 19 shows an overlay of differential scanning calorimetry (DSC) plots for analysis of the glass transition temperatures, T_{g}, for ORION solid electrolytes are SBU(SO₃⁻):NaTFSI:DME (—O—)=1:1:x (where x=1.0, 1.5, 2.0, 2.5, or 3.0).

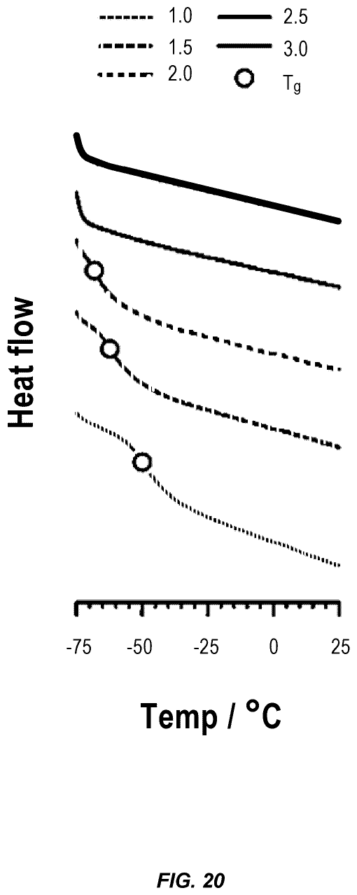

FIG. 20 shows an overlay of differential scanning calorimetry (DSC) plots for analysis of the glass transition temperatures, T_{g}, for ORION solid electrolytes are SBU(SO₃⁻):NaTFSI:DEGDME (—O—)=1:1:x (where x=1.0, 1.5, 2.0, 2.5, or 3.0).

### Ionic Conductivity

Ionic conductivity of Na ORION electrolytes was examined with electrochemical impedance spectroscopy (EIS) using VMP3 potentiostat (BioLogic, Seyssinet-pariset, France). Na ORION electrolytes were embedded in PEEK washer and stainless steel (SUS) plate was used as an electrode to confine area and distance between the electrodes inside a 2032 coin cell. EIS change was measured with increasing temperature from 20-70° C.

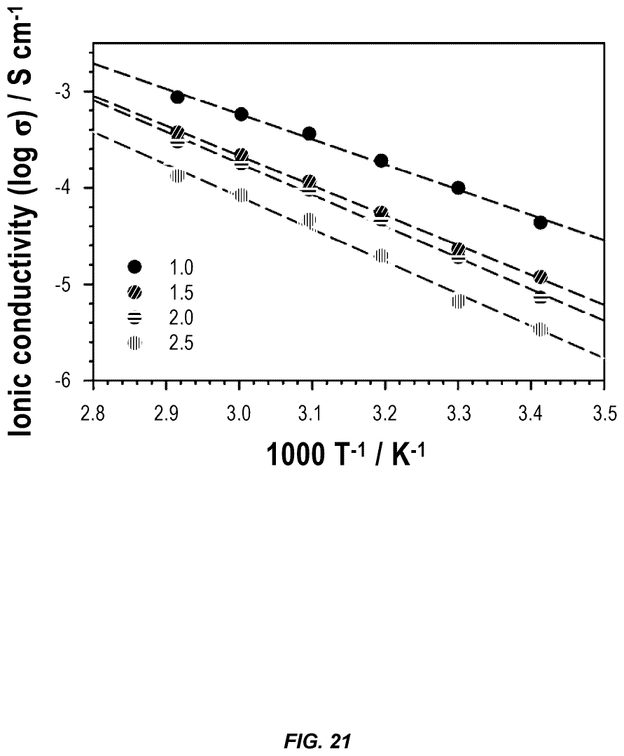

FIG. 21 shows an ionic conductivity plot for ORION solid electrolytes are SBU(SO₃⁻):NaTFSI:DME (—O—)=1:1:x (where x=1.0, 1.5, 2.0, or 2.5).

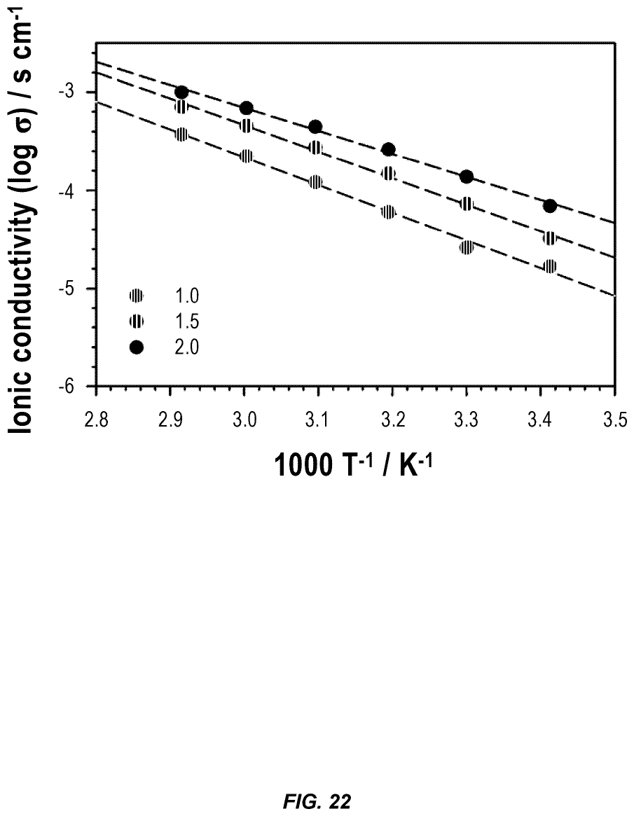

FIG. 22 shows an ionic conductivity plot for ORION solid electrolytes are SBU(SO₃⁻):NaTFSI:DEGDME (—O—)=1:1:x (where x=1.0, 1.5, 2.0, or 2.5)

### Electrochemical Characterization

Na symmetric cell cycling was examined with Na ORION electrolyte with composition of SBU(SO₃⁻):NaTFSI:DEGDME (—O—)=1.0:1.0:2.0, which showed highest ionic conductivity. The ORION electrolyte was embedded in PEEK washer and Na metal was attached to each side of washer. The Na|ORION|Na was placed in a 2032 coin cell. The cycling was conducted with a current density of 0.03 mA cm⁻² at 60° C.

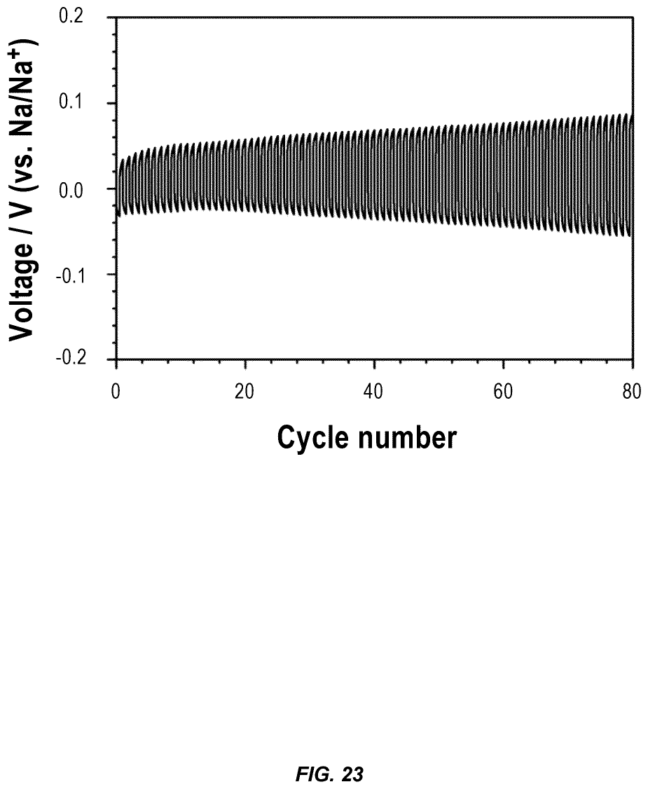

FIG. 23 shows the voltage profile of Na|ORION|Na cycling. The ORION electrolyte is SBU(SO₃⁻):NaTFSI:DEGDME (—O—)=1:1:2.0. The symmetric cell was cycled with a current density of 0.03 mA cm⁻².

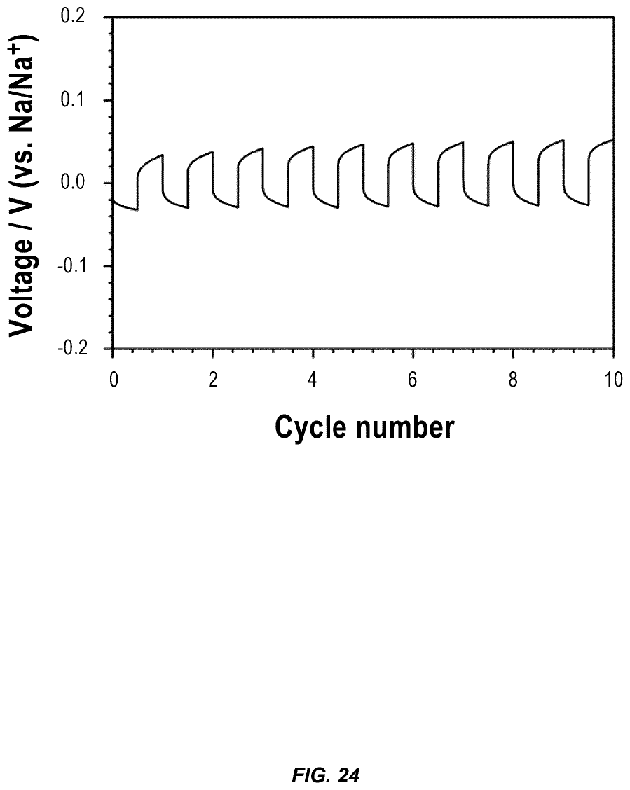

FIG. 24 shows the voltage profile of the sodium symmetric cell (Na|ORION|Na) cycling from FIG. 23 across cycles 1-10.

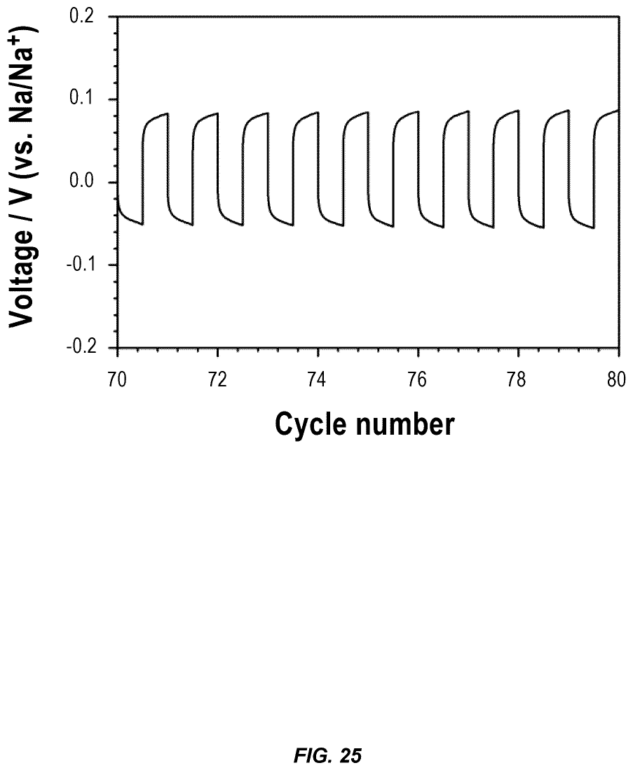

FIG. 25 shows the voltage profile of sodium symmetric cell (Na|ORION|Na) cycling from FIG. 23 across cycles 70-80.

### REFERENCES

Q. Zhao, S. Stalin, C. Z. Zhao, L. A. Archer, Designing solid-state electrolytes for safe, energydense batteries. Nat. Rev. Mater. 5, 229-252 (2020).
J. Janek, W. G. Zeier, Challenges in speeding up solid-state battery development. Nat. Energy 8, 230-240 (2023).
J. Lee, T. Lee, K. Char, K. J. Kim, J. W. Choi, Issues and advances in scaling up sulfide-based all-solid-state batteries. Acc. Chem. Res. 54, 3390-3402 (2021).
K. J. Huang, G. Ceder, E. A. Olivetti, Manufacturing scalability implications of materials choice in inorganic solid-state batteries. Joule 5, 564-580 (2021).
D. H. S. Tan, A. Banerjee, Z. Chen, Y. S. Meng, From nanoscale interface characterization to sustainable energy storage using all-solid-state batteries. Nat. Nanotechnol. 15, 170-180 (2020).
L. Azhari, S. Bong, X. T. Ma, Y. Wang, Recycling for all solid-state lithium-ion batteries. Matter 3, 1845-1861 (2020).
M. Chen, X. Ma, B. Chen, R. Arsenault, P. Karlson, N. Simon, Y. Wang, Recycling end-of-life electric vehicle lithium-ion batteries. Joule 3, 2622-2646 (2019).
E. Fan, L. Li, Z. Wang, J. Lin, Y. Huang, Y. Yao, R. Chen, F. Wu, Sustainable recycling technology for Li-ion batteries and beyond: Challenges and future prospects. Chem. Rev. 120, 7020-7063 (2020).
Q. Zhao, X. Liu, S. Stalin, K. Khan, L. A. Archer, Solid-state polymer electrolytes with in-built fast interfacial transport for secondary lithium batteries. Nat. Energy 4, 365-373 (2019).
K. Xu, Electrolytes and interphases in Li-ion batteries and beyond. Chem. Rev. 114, 11503-11618 (2014).
Y. Yamada, J. H. Wang, S. Ko, E. Watanabe, A. Yamada, Advances and issues in developing salt-concentrated battery electrolytes. Nat. Energy 4, 269-280 (2019).
M. J. Lee, J. Han, K. Lee, Y. J. Lee, B. G. Kim, K. N. Jung, B. J. Kim, S. W. Lee, Elastomeric electrolytes for high-energy solid-state lithium batteries. Nature 601, 217-222 (2022).
F. F. Chen, X. E. Wang, M. Armand, M. Forsyth, Cationic polymer-in-salt electrolytes for fast metal ion conduction and solid-state battery applications. Nat. Mater. 21, 1175-1182 (2022).
S. D. Jones, H. Nguyen, P. M. Richardson, Y. Q. Chen, K. E. Wyckoff, C. J. Hawker, R. J. Clement, G. H. Fredrickson, R. A. Segalman, Design of polymeric zwitterionic solid electrolytes with superionic lithium transport. ACS. Central. Sci. 8, 169-175 (2022).
F. Makhlooghiazad, L. A. O'Dell, L. Porcarelli, C. Forsyth, N. Quazi, M. Asadi, O. Hutt, D. Mecerreyes, M. Forsyth, J. M. Pringle, Zwitterionic materials with disorder and plasticity and their application as non-volatile solid or liquid electrolytes. Nat. Mater. 21, 228-236 (2022).
M. Armand, F. Endres, D. R. MacFarlane, H. Ohno, B. Scrosati, Ionic-liquid materials for the electrochemical challenges of the future. Nat. Mater. 8, 621-629 (2009).
S. Safaei, I. Mohammadpoor-Baltork, A. R. Khosropour, M. Moghadam, S. Tangestaninejad, V. Mirkhani, R. Kia, Application of a multi-SO3H Bronsted acidic ionic liquid in water: A highly efficient and reusable catalyst for the regioselective and scaled-up synthesis of pyrazoles under mild conditions. RSC Adv. 2, 5610-5616 (2012).
D. Brouillette, D. E. Irish, N. J. Taylor, G. Perron, M. Odziemkowski, J. E. Desnoyers, Stable solvates in solution of lithium bis(trifluoromethylsulfone)imide in glymes and other aprotic solvents: Phase diagrams, crystallography and raman spectroscopy. Phys. Chem. Chem. Phys. 4, 6063-6071 (2002).
V. Hildebrand, A. Laschewsky, M. Pach, P. Muller-Buschbaum, C. M. Papadakis, Effect of the zwitterion structure on the thermo-responsive behaviour of poly(sulfobetaine methacrylates). Polym. Chem. 8, 310-322 (2017).
J. Bae, Y. Li, J. Zhang, X. Zhou, F. Zhao, Y. Shi, J. B. Goodenough, G. Yu, A 3D nanostructured hydrogel-framework-derived high-performance composite polymer lithium-ion electrolyte. Angew. Chem. Int. Ed. 57, 2096-2100 (2018).
C. Y. Fu, V. Venturi, J. Kim, Z. Ahmad, A. W. Ells, V. Viswanathan, B. A. Helms, Universal chemomechanical design rules for solid-ion conductors to prevent dendrite formation in lithium metal batteries. Nat. Mater. 19, 758-766 (2020).
Z. Ahmad, V. Viswanathan, Stability of electrodeposition at solid-solid interfaces and implications for metal anodes. Phys. Rev. Lett. 119, 056003 (2017).
Y. Lu, C. Z. Zhao, H. Yuan, X. B. Cheng, J. Q. Huang, Q. Zhang, Critical current density in solid-state lithium metal batteries: Mechanism, influences, and strategies. Adv. Funct. Mater. 31, 2009925 (2021).
J. Lopez, D. G. Mackanic, Y. Cui, Z. Bao, Designing polymers for advanced battery chemistries. Nat. Rev. Mater. 4, 312-330 (2019).
F. Shi, A. Pei, D. T. Boyle, J. Xie, X. Yu, X. Zhang, Y. Cui, Lithium metal stripping beneath the solid electrolyte interphase. Proc. Natl. Acad. Sci. U.S.A. 115, 8529-8534 (2018).
J. Liu, Z. Bao, Y. Cui, E. J. Dufek, J. B. Goodenough, P. Khalifah, Q. Li, B. Y. Liaw, P. Liu, A. Manthiram, Y. S. Meng, V. R. Subramanian, M. F. Toney, V. V. Viswanathan, M. S. Whittingham, J. Xiao, W. Xu, J. Yang, X. Q. Yang, J. G. Zhang, Pathways for practical high-energy long-cycling lithium metal batteries. Nat. Energy 4, 180-186 (2019).
P. Albertus, S. Babinec, S. Litzelman, A. Newman, Status and challenges in enabling the lithium metal electrode for high-energy and low-cost rechargeable batteries. Nat. Energy 3, 16-21 (2018).
R. Koerver, I. Aygun, T. Leichtweis, C. Dietrich, W. Zhang, J. O. Binder, P. Hartmann, W. G. Zeier, J. Janek, Capacity fade in solid-state batteries: Interphase formation and chemomechanical processes in nickel-rich layered oxide cathodes and lithium thiophosphate solid electrolytes. Chem. Mater. 29, 5574-5582 (2017).
Y. Xiao, K. Turcheniuk, A. Narla, A. Y. Song, X. Ren, A. Magasinski, A. Jain, S. Huang, H. Lee, G. Yushin, Electrolyte melt infiltration for scalable manufacturing of inorganic all-solidstate lithium-ion batteries. Nat. Mater. 20, 984-990 (2021).
J. Lee, K. Lee, T. Lee, H. Kim, K. Kim, W. Cho, A. Coskun, K. Char, J. W. Choi, In situ deprotection of polymeric binders for solution-processible sulfide-based all-solid-state batteries. Adv. Mater. 32, 2001702 (2020).
D. H. Kim, D. Y. Oh, K. H. Park, Y. E. Choi, Y. J. Nam, H. A. Lee, S. M. Lee, Y. S. Jung, Infiltration of solution-processable solid electrolytes into conventional Li-ion-battery electrodes for all-solid-state Li-ion batteries. Nano Lett. 17, 3013-3020 (2017).
K. J. Harry, D. T. Hallinan, D. Y. Parkinson, A. A. MacDowell, N. P. Balsara, Detection of subsurface structures underneath dendrites formed on cycled lithium metal electrodes. Nat. Mater. 13, 69-73 (2014).
M. J. Baran, M. E. Carrington, S. Sahu, A. Baskin, J. Song, M. A. Baird, K. S. Han, K. T. Mueller, S. J. Teat, S. M. Meckler, C. Fu, D. Prendergast, B. A. Helms, Diversity-oriented synthesis of polymer membranes with ion solvation cages. Nature 592, 225-231 (2021).
V. Wood, X-ray tomography for battery research and development. Nat. Rev. Mater. 3, 293-295 (2018).
W. L. Fredericks, S. Sripad, G. C. Bower, V. Viswanathan, Performance metrics required of next-generation batteries to electrify vertical takeoff and landing (VTOL) aircraft. ACS Energy Lett. 3, 2989-2994 (2018).
V. Viswanathan, B. M. Knapp, Potential for electric aircraft. Nat. Sustain. 2, 88-89 (2019).
S. Sripad, V. Viswanathan, Quantifying the economic case for electric semi-trucks. ACS Energy Lett. 4, 149-155 (2019).
M. K. Tran, M. T. F. Rodrigues, K. Kato, G. Babu, P. M. Ajayan, Deep eutectic solvents for cathode recycling of Li-ion batteries. Nat. Energy 4, 339-345 (2019).
Y. Wang, D. Lu, M. Bowden, P. Z. el Khoury, K. S. Han, Z. D. Deng, J. Xiao, J. G. Zhang, J. Liu, Mechanism of formation of Li7P3S11 solid electrolytes through liquid phase synthesis. Chem. Mater. 30, 990-997 (2018).
S. Plimpton, Fast parallel algorithms for short-range molecular dynamics. J. Comput. Phys. 117, 1-19 (1995).
B. Doherty, X. Zhong, S. Gathiaka, B. Li, O. Acevedo, Revisiting OPLS force field parameters for ionic liquid simulations. J. Chem. Theory Comput. 13, 6131-6145 (2017).
L. S. Dodda, I. Cabeza de Vaca, J. Tirado-Rives, W. L. Jorgensen, LigParGen web server: An automatic OPLS-AA parameter generator for organic ligands. Nucleic Acids Res. 45, W331-W336 (2017).
L. S. Dodda, J. Z. Vilseck, J. Tirado-Rives, W. L. Jorgensen, 1.14*CMIA-LBCC: Localized bondcharge corrected CM1A charges for condensed-phase simulations. J. Phys. Chem. B 121, 3864-3870 (2017).
W. L. Jorgensen, J. Tirado-Rives, Potential energy functions for atomic-level simulations of water and organic and biomolecular systems. Proc. Natl. Acad. Sci. U.S.A. 102, 6665-6670 (2005).
J. N. Canongia Lopes, A. A. H. Padua, Molecular force field for ionic liquids composed of triflate or bistriflylimide anions. J. Phys. Chem. B 108, 16893-16898 (2004).
K. P. Jensen, W. L. Jorgensen, Halide, ammonium, and alkali metal ion parameters for modeling aqueous solutions. J. Chem. Theory Comput. 2, 1499-1509 (2006).
K. P. Jensen, W. L. Jorgensen, Computer Simulation Using Particles (Adam Hilger, 1989).
L. Martinez, R. Andrade, E. G. Birgin, J. M. Martinez, PACKMOL: A package for building initial configurations for molecular dynamics simulations. J. Comput. Chem. 30, 2157-2164 (2009).
N. Michaud-Agrawal, E. J. Denning, T. B. Woolf, O. Beckstein, MDAnalysis: A toolkit for the analysis of molecular dynamics simulations. J. Comput. Chem. 32, 2319-2327 (2011).

### STATEMENTS REGARDING INCORPORATION BY REFERENCE AND VARIATIONS

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and sub-combinations possible of the group are intended to be individually included in the disclosure. As used herein, “and/or” means that one, all, or any combination of items in a list separated by “and/or” are included in the list; for example, “1, 2 and/or 3” is equivalent to “1, 2, 3, 1 and 2, 1 and 3, 2 and 3, or 1, 2 and 3”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by examples, embodiments, and optional features, modification and variation of the concepts herein disclosed may be resorted to by those skilled in the art, and that such modifications and variations are considered to be within the scope of this invention as defined by the appended claims.

What is claimed is:

1. A supramolecular organo-ionic electrolyte, comprising:
a supramolecular building unit;
an alkali metal salt;
a coordinating ligand; and
optionally, a zwitterionic polymer.

2. The supramolecular organo-ionic electrolyte of claim 1, wherein the supramolecular building unit is a polyfunctional zwitterionic small molecule according to Formula I: 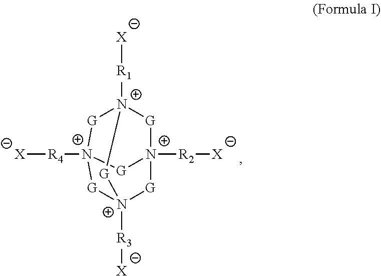
wherein,
R₁, R₂, R₃, and R₄ are independently selected from a substituted or unsubstituted C₁₋₁₂ alkyl,
G is C₁₋₆ alkyl, and
X is —SO₃⁻, —CO₂⁻, —BF₃⁻, —CH₂—(CO⁻)—CH—CO—Y, —SO₂—N⁻—SO₂—Y, wherein Y is F, CF₃, a substituted or unsubstituted alky, a substituted or unsubstituted aryl, a substituted or unsubstituted haloalkyl, or a substituted or unsubstituted haloaryl.

3. The supramolecular organo-ionic electrolyte of claim 1, wherein the alkali metal salt is a lithium ion salt, a sodium ion salt, or a potassium ion salt.

4. The supramolecular organo-ionic electrolyte of claim 3, wherein the lithium-ion salt is selected from the group consisting of LiFSI, LiTFSI, LiOTf, LiClO₄, LiBF₄, LiDFOB, and LiPF₆, and wherein the sodium ion salt is selected from the group consisting of NaFSI, NaTFSI, NaOTf, NaClO₄, NaBF₄, NaBH₄, NaDFOB, and NaPF₆.

5. The supramolecular organo-ionic electrolyte of claim 1, wherein the coordinating ligand is an ether, a carbonate, a sulfoxide, a sulfone, an amide, a sulfonamide, a phosphoramide, or combinations thereof.

6. The coordinating ligand of claim 5, wherein the ether is 1,2-dimethoxy ethane (DME) or a glyme of Formula II: 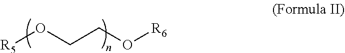
wherein,
R₅ and R₆ are independent selected from a substituted or unsubstituted alky, a substituted or unsubstituted aryl, a substituted or unsubstituted haloalkyl, a substituted or unsubstituted haloaryl, or combinations thereof, and
n is 1, 2, 3, or 4.

7. The supramolecular organo-ionic electrolyte of claim 1, wherein the zwitterionic polymer is a viscosity modifier comprising 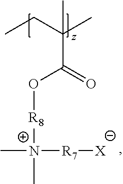
wherein:
z is an integer from 10 to 500; and
R₇ and R₅ are independently C₁₋₆ alkyl.

8. The supramolecular organo-ionic electrolyte of claim 7, wherein R₈ is C₂ alkyl and R₇ is C₃ alkyl.

9. The supramolecular organo-ionic electrolyte of claim 8, wherein the zwitterionic polymer is poly(sulfobetaine methacrylate)(PSBMA).

10. The supramolecular organo-ionic electrolyte of claim 2, wherein the polyfunctional zwitterionic small molecule according to Formula I is:

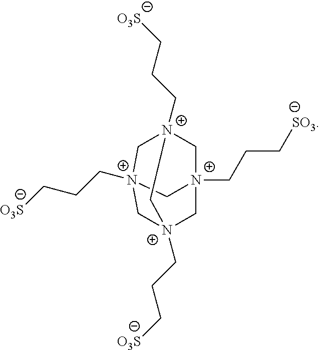

11. The supramolecular organo-ionic electrolyte of claim 10, comprising a —SO₃⁻:Li⁺ molar ratio of 1:x, wherein x is an integer from 1 to 4.

12. The supramolecular organo-ionic electrolyte of claim 11, wherein the —SO₃⁻:Li⁺ molar ratio is 1:2.

13. The supramolecular organo-ionic electrolyte of claim 8, wherein the the zwitterionic polymer is poly(sulfobetaine methacrylate)(PSBMA) and wherein the PSBMA is up to about 10% (w/w) relative to the polyfunctional zwitterionic small molecule of Formula I.

14. The supramolecular organo-ionic electrolyte of claim 1, further comprising an additive, wherein the additive comprises a fluoroalkyl ether, a fluoroalkyl acetal, a fluoroalkyl orthoester, a fluoroalkyl carbonate, a fluoroalkyl phosphonate, or combinations thereof.

15. An all-solid-state electrochemical metal cell, comprising:
an anode active material;
a cathode active material;
a separator; and
a supramolecular organo-ionic electrolyte according to claim 1, wherein the supramolecular organo-ionic electrolyte is positioned between the anode active material and the cathode active material.

16. The all-solid-state electrochemical metal cell of claim 15, wherein the anode active material is lithium metal, a lithium alloy, sodium metal, a sodium alloy, potassium metal, a potassium alloy, hard carbon, graphite, silicon, or combinations thereof.

17. The all-solid-state electrochemical metal cell of claim 15, wherein the cathode active material is lithium iron phosphate (LFP) or LiNi_{0.5}Mn_{0.3}Co_{0.2}O₂ (NMC532).

18. The all-solid state electrochemical metal cell of claim 15, wherein the separator can be porous, particulate, fiber, or woven from electronically insulating materials further comprising a glass, a ceramic, or a polymeric material.

19. The all-solid-state electrochemical metal cell of claim 15, comprising a retention of at least 80% capacity after 100 cycles at a rate up to 0.1 mA cm⁻² at 45° C.

20. The all-solid-state electrochemical metal cell of claim 15, comprising a battery operating temperature between −40° C. and 45° C.
